(19) United States
(12) Patent Application Publication
(10) Pub. No.: US 2006/0062889 A1
(43) Pub. Date: Mar. 23, 2006

(54) Soy protein-containing composition

(75) Inventors: Smith S. Houston, St. Louis, MO (US); Zahid Mozaffar, Ballwin, MO (US); Theodore C. Busch, St. Louis, MO (US); Scott E. Ruppe, High Ridge, MO (US)

Correspondence Address: SOLAE, LLC, P. O. BOX 88940, ST. LOUIS, MO, 63188, US

(73) Assignee: SOLAE, LLC.

(21) Appl. No.: 10/943,759

(22) Filed: Sep. 17, 2004

(51) Int. Cl. A23L 1/20

(52) U.S. Cl. 426/634

(57) ABSTRACT

The present invention relates to soy protein-containing compositions having improved flavor, odor, appearance, and/or functionality.

### FIELD OF THE INVENTION

The present invention relates to soy protein-containing compositions having improved flavor, odor, appearance, and/or functionality.

### BACKGROUND OF THE INVENTION

Plant protein materials are used as functional food ingredients, and have numerous applications in enhancing desirable characteristics in food products. Soy protein materials, in particular, have seen extensive use as functional food ingredients. Soy protein materials are used as an emulsifier in meats, including frankfurters, sausages, bologna, ground and minced meats and meat patties, to bind the meat and give the meat a good texture and a firm bite. Another common application for soy protein materials as functional food ingredients is in creamed soups, gravies, and yogurts where the soy protein material acts as a thickening agent and provides a creamy viscosity to the food product. Soy protein materials are also used as functional food ingredients in numerous other food products such as dips, dairy products, tuna, breads, cakes, macaroni, confections, whipped toppings, baked goods, and many other applications.

In general, soy protein materials include soy flakes, soy grits, soy meal, soy flour, soy protein concentrates, and soy protein isolates with a primary difference between these materials being the degree of refinement relative to whole soybeans.

Soy flakes are generally produced by dehulling, defatting, and grinding the soybean and typically contain less than 65 wt. % soy protein on a moisture-free basis. Soy flakes also contain soluble carbohydrates, insoluble carbohydrates such as soy fiber, and fat inherent in soy. Soy flakes may be defatted, for example, by extraction with hexane. Soy flours, soy grits, and soy meals are produced from soy flakes by comminuting the flakes in grinding and milling equipment such as a hammer mill or an air jet mill to a desired particle size. The comminuted materials are typically heat treated with dry heat or steamed with moist heat to “toast” the ground flakes and inactivate anti-nutritional elements present in soy such as trypsin inhibitors. Heat treating the ground flakes in the presence of significant amounts of water is avoided to prevent denaturation of the soy protein in the material and to avoid costs involved in the addition and removal of water from the soy material. The resulting ground, heat treated material is a soy flour, soy grit, or a soy meal, depending on the average particle size of the material. Soy flour generally has a particle size of less than 150 μm. Soy grits generally have a particle size of 150 to 1000 μm. Soy meal generally has a particle size of greater than 1000 μm.

Soy protein concentrates typically contain 65 wt. % to 90 wt. % soy protein, on a moisture-free basis, with the major non-protein component being fiber. Soy protein concentrates may be formed from soy flakes by washing the flakes with either an aqueous alcohol solution or an acidic aqueous solution to remove the soluble carbohydrates from the protein and fiber. On a commercial scale, considerable costs are incurred with the handling and disposing of the resulting waste stream.

Soy protein isolates, more highly refined soy protein materials, are processed to contain at least 90% soy protein on a moisture-free basis and little or no soluble carbohydrates or fiber. Soy protein isolates are typically formed by extracting soy protein and water soluble carbohydrates from soy flakes or soy flour with an alkaline aqueous extractant. The aqueous extract, along with the soluble protein and soluble carbohydrates, is separated from materials that are insoluble in the extract, mainly fiber. The extract is then treated with an acid to adjust the pH of the extract to the isoelectric point of the protein to precipitate the protein from the extract. The precipitated protein is separated from the extract, which retains the soluble carbohydrates, and is dried after being adjusted to a neutral pH or is dried without any pH adjustment. On a commercial scale, these steps contribute significant cost to the product.

In addition to the soy protein content, flavor, odor, color, and functionality of a soy protein material are also a relevant criteria for the selection of a soy protein material as a functional food ingredient. Conventional soy protein material may have a strong beany, bitter flavor and odor as a result of the presence of certain volatile compounds (e.g., hexanal, pentanal, pentyl furan, and octanal) and/or an undesired appearance due to the presence of other relatively low molecular weight compounds (e.g., isoflavones) in the soy protein material.

### SUMMARY OF THE INVENTION

Among the various aspects of the invention, therefore, is the provision of a soy protein-containing composition having improved flavor, odor, appearance, and/or functionality.

Briefly, therefore, one aspect of the present invention is a composition comprising a soy protein material, the composition being in solid or liquid form, the composition being characterized in that an aqueous mixture of the composition has a whiteness index of at least 50 and an L value of less than 78 when the aqueous mixture has a soy protein content of 2 to 3% by weight and a pH of 6.8 to 7.2. The whiteness index (WI) is determined using the equation WI=L−3b and L and b are determined using a calorimeter, L being a measure of the whiteness of the composition with the value of L ranging from 0 to 100 with increasing whiteness and b being a measure of the presence of yellow or blue colors in the composition, with positive b values indicating the presence of yellow colors and negative b values indicating the presence of blue colors.

The present invention is further directed to a composition comprising a soy protein material and one or more isoflavones selected from: (i) aglucone and non aglucone type daidzin, daidzein, genistin, genistein, glycitin, and glycitein isoflavones and (ii) the malonyl and acetyl esters of aglucone and non aglucone type daidzin, daidzein, genistin, genistein, glycitin, and glycitein isoflavones, wherein the weight ratio of soy protein to the combined weight of all such isoflavones is at least 3,000:1, respectively.

Compositions of the present invention may be prepared by a process comprising introducing a feed soy protein-containing material into a contact vessel containing a mass of an adsorbent resin to form a mixture within an adsorption zone of the contact vessel to treat the soy protein-containing material, the resin being selective for adsorption of one or more components of the feed soy protein-containing material; agitating the mixture to form a dispersion of the resin in the composition, the resin being free to move throughout the dispersion in the adsorption zone to form a treated soy protein-containing material; and removing the treated soy protein-containing material from the contact vessel as the feed is introduced into the contact vessel.

Compositions of the present invention may also be prepared by a process comprising feeding a food-grade, soy protein-containing material to a chromatographic separation zone, the chromatographic separation zone comprising a bed of size exclusion resin, the resin having a size exclusion limit. The process further comprises passing the food-grade soy protein-containing material through the bed of size exclusion resin to reduce the concentration of components having a molecular weight less than the size exclusion limit of the resin in the food-grade material to form a reduced component concentration soy protein-containing material; and eluting the reduced component concentration soy protein-containing material from the chromatographic separation zone after it has passed through the bed of size exclusion resin.

Compositions of the present invention may also be prepared by a process comprising feeding a soy protein-containing material to a chromatographic separation zone, the soy protein-containing material comprising at least two soy proteins having a molecular weight of at least 50,000 daltons, the chromatographic separation zone comprising a bed of size exclusion resin having a size exclusion limit of S, wherein S is no more than 50,000 daltons, whereby components of the soy protein material having a molecular weight less than S are retained by the resin and components having a molecular weight greater than S are not retained by the resin. The process further comprises passing the soy protein-containing material through the bed of size exclusion resin to reduce the concentration of components having a molecular weight less than the size exclusion limit of the resin in the soy protein-containing material to form a reduced component concentration soy protein material; and eluting the reduced component concentration soy protein material from the chromatographic separation zone after it has passed through the bed of size exclusion resin wherein the weight ratio of any two soy proteins having a molecular weight of at least 50,000 daltons in the eluted composition is within 20% of the weight ratio of the same two soy proteins in the feed soy protein-containing material.

Other objects and features of this invention will be in part apparent and in part pointed out hereinafter.

### BRIEF DESCRIPTION OF THE DRAWINGS

FIG. 1 schematically depicts an apparatus suitable for use in one embodiment of a process for preparing the soy protein-containing composition of the present invention.

FIG. 2 schematically depicts an apparatus suitable for use in one embodiment of a process for preparing the soy protein-containing composition of the present invention.

FIG. 3 is a High Performance Liquid Chromatography (HPLC) pattern for a treated soy protein-containing composition prepared in accordance with the process described in Example 13.

FIG. 4 is a High Performance Liquid Chromatography (HPLC) pattern for a treated soy protein-containing composition prepared in accordance with the process described in Example 14.

### DETAILED DESCRIPTION OF THE PREFERRED EMBODIMENTS

The present invention provides improved soy protein-containing compositions which exhibit improved flavor, odor, appearance (e.g., color), and/or functionality characteristics which make these compositions desirable for use as functional food ingredients.

The soy protein-containing compositions of the present invention may be derived from soy plants whether wild-type, hybrid, or genetically modified by recombinant techniques. Alternatively, the material may be derived from other plant species which have been genetically modified to express a protein naturally expressed by a wild-type soy plant. Naturally occurring soy proteins are generally globular proteins having a hydrophobic core surrounded by a hydrophilic shell. Numerous soy proteins have been identified including, for example, storage proteins such as glycinin and—congylcinin, trypsin inhibitors such as the Bowman-Birk inhibitor and the Kunitz inhibitor, and hemagglutinins such as lectin. These proteins have varying molecular weights which, generally, range from 8,000 to 650,000 daltons. Of course, the soy plant may be transformed to produce other proteins not naturally expressed by soy plants. These recombinantly expressed proteins will also generally have a range of molecular weights. Typically, therefore, the soy protein-containing compositions comprise a mixture of at least two soy proteins whether native or recombinant having a molecular weight of at least 50,000 daltons.

The soy protein-containing composition may be in the form of a solid (e.g., a free-flowing powder or other solid material) including a soy protein material. In the case of a solid composition, the soy protein material may be in the form of soy flakes, soy flour, soy grits, soy meal, a soy protein concentrate, a soy protein isolate, or combinations thereof. Advantageously, solid soy protein-containing compositions of the present invention often exhibit a high purity (i.e., high soy protein content). Typically, such compositions contain at least 90% by weight soy protein on a moisture-free basis, at least 95% by weight soy protein on a moisture-free basis or even at least 98% by weight soy protein on a moisture-free basis. The amount of protein in soy protein material may be ascertained, for example, by the Nitrogen-Ammonia-Protein Modified Kjeldahl Method of A.O.C.S. (American Oil Chemists Society) Official Methods Bc 4-91(1997), Aa 5-91(1997), or Ba 4d-90(1997).

Alternatively, the soy protein-containing composition may be in the form of a liquid, e.g., an admixture of soy protein material and an aqueous medium (e.g., water). In the case of a liquid composition, the soy protein material may be derived from or an aqueous mixture of soy flakes, soy flour, soy grits, soy meal, a soy protein concentrate, a soy protein isolate, or combinations thereof.

In various embodiments, the soy protein-containing materials have substantially improved, and in some embodiments, previously unattained flavor, odor, appearance (e.g. color), functionality characteristics, and/or other characteristics (e.g., reduced inducement of intestinal gas and flatulence in humans) which make these compositions desirable for use as functional food ingredients. The advantageous features of the soy protein-containing materials of the present invention are generally believed to be due to their generally low content of relatively low molecular weight components which contribute undesirable flavor, odor, appearance (e.g., color), and/or other characteristics (e.g., inducing intestinal gas and flatulence in humans) to soy protein materials as compared to many conventional soy protein-containing materials. In general, these low molecular weight components include volatile and nonvolatile components having a molecular weight of at least 80 daltons and, typically, having a molecular weight in the range of from 80 daltons to 17,000 daltons, or from 1000 daltons to 17,000 daltons. The volatile components contributing to undesired flavor and odor of soy protein materials include, for example, 3-methyl butanal, 2-methyl butanal, pentanal, dimethyl disulfide, hexanal, heptanal, 2,5-octanedione, 1-octen-3-ol, 2-octanone, 2-pentyl furan, 3-octen-2-one, 3,5-octadien-2-one, 2-nonanone, nonanal, and other compounds identified in Table 1. The nonvolatile components contributing to undesired flavor and color of soy protein materials include, for example, isoflavones. Such isoflavones include, for example, the daidzein, genistein, and glycitein isoflavones. Exemplary daidzein isoflavones include 6-OMal-daidzin and 6-OAc-daidzin. Exemplary genistein isoflavones include 6-OMal-genistin and 6-OAc-genistin. Glycitein isoflavones include 6-OMal-glycitin. The nonvolatile components contributing to inducing intestinal gas and flatulence in humans include, for example, fructose, glucose, sucrose, maltose, lactose, stachyose, and raffinose.

A soy protein-containing material of the present invention typically has a total low molecular weight component content of no more than 500 parts per million (ppm), more typically of no more than 350 ppm and, still more typically, of no more than 200 ppm. The total low molecular weight component content of a soy protein-containing composition of the present invention indicates the proportion of those components of the composition (i) having a molecular weight of from 80 to 17,000 daltons and (ii) which absorb ultraviolet radiation having a wavelength of from 200 to 400 nanometers (nm).

The improved flavor and odor characteristics of the soy protein-containing compositions of the present invention are due to a relatively low content of certain volatile components. These volatile components include, for example, certain aldehydes and ketones having less than ten carbon atoms (e.g., pentanal, hexanal, etc.) mentioned above. Particular flavors and odors have been specifically associated with certain volatile components, some of which are summarized below in Table 1.

TABLE 1

| Flavor/Odor | Volatile Component |
|---|---|
| Green, grassy, beany | Pentan-1-ol, Hexan-1-ol, Heptan-1-ol, 3- |
| | Methylbutan-1-ol, Oct-1-en-3-ol, Pentanal, |
| | Hexanal, Heptanal, cis- and trans-pent-2-enal, cis- |
| | Hex-3-enal, trans-Hex-2-enal, Hept-2-enal, Hexa- |
| | trans-2,trans-4-dienal, Nona-2,4-dienal, Nona- |
| | trans-2,cis-6-dienal, Deca-2,4-dienal, Undecan-2- |
| | one, Butenone, Pent-1-en-3-one, Oct-3-en-2-one, |
| | Dec-1-yne, 2-Pentylfuran, cis- and trans-2-(pent- |
| | 1-enyl)furan, and cis- and trans-2-(pent-2- |
| | enyl)furan |
| Cooked soybean, | Vinylphenol and 4-Vinylguaiacol |
| repulsive | |
| Cooked vegetable | Dimethyl sulfide |
| (e.g., cabbage) | |
| Deep-fried | Deca-trans-2,trans-4-dienal |
| Buttery | Butanedione and Pentane-2,3-dione |
| Oily, fatty, tallow-like, | Hexanal, Heptanal, Octanal, Nonanal, cis- |
| and putty | and trans-hept-2-enal, cis- and trans-oct-2-enal, |
| | Non-2-enal, trans-Non-3-enal, trans-Dec-2-enal, |
| | trans-Undec-2-enal, Hepta-trans-2,trans-4-dienal, |
| | Nona-trans-2,trans-4-dienal, Nona-trans-2,trans-6- |
| | dienal, Deca-2,4-dienal, and Oct-3-en-2-one |
| Musty, moldy, and | Oct-1-en-3-ol, Geosmin and Acetophenone |
| earthy | |
| Mushroom | Oct-1-en-3-ol and Oct-1-en-3-one. |
| Oxidized, cardboard- | Higher alka-2,4-dienals (e.g., C₇, C₈, C₉, C₁₀) |
| like, oily, and | |
| paint-like | |
| Fishy | Aliphatic amines, cis-Hept-4-enal, and Deca- |
| | trans-2,cis-4,cis-7-trienal |

Generally, the soy protein-containing compositions have a substantially reduced green, grassy, beany, oily, fatty, tallow-like, or putty off flavor as compared to conventional soy protein-containing compositions. Typically, a soy protein-containing composition of the present invention has a total volatile component content of no more than 150 parts per billion (ppb), more typically no more than 100 ppb and, still more typically, no more than 50 ppb. The total volatile component content of the soy protein-containing composition represents the total proportion of aldehydes containing less than 10 carbon atoms, ketones containing less than 10 carbon atoms, and combinations thereof, present in the treated soy protein-containing composition.

Many soy protein-containing compositions (e.g., a free-flowing powder including treated soy protein or an aqueous mixture containing treated soy protein) will have, to varying degrees, a yellowish or brownish color. “Whiteness index” is one measure of the color of soy protein-containing compositions. In general, the soy protein-containing compositions of the present invention and aqueous mixtures containing them exhibit improved color, i.e., increased whiteness index, as compared to various other soy protein-containing compositions. In general, the whiteness index is determined using a calorimeter which provides the L, a, and b color values for the composition from which the whiteness index may be calculated using a standard expression of the Whiteness Index (WI), WI=L−3b. The L component generally indicates the whiteness or, “lightness”, of the sample; L values near 0 indicate a black sample while L values near 100 indicate a white sample. The b value indicates yellow and blue colors present in the sample; positive b values indicate the presence of yellow colors while negative b values indicate the presence of blue colors. The a value, which may be used in other color measurements, indicates red and green colors; positive values indicate the presence of red colors while negative values indicate the presence of green colors. For the b and a values, the absolute value of the measurement increases directly as the intensity of the corresponding color increases. Generally, the colorimeter is standardized using a white standard tile provided with the calorimeter. A sample is then placed into a glass cell which is introduced to the calorimeter. The sample cell is covered with an opaque cover to minimize the possibility of ambient light reaching the detector through the sample and serves as a constant during measurement of the sample. After the reading is taken, the sample cell is emptied and typically refilled as multiple samples of the same material are generally measured and the whiteness index of the material expressed as the average of the measurements. Suitable colorimeters generally include those manufactured by HunterLab (Reston, Va.) including, for example, Model # DP-9000 with Optical Sensor D 25.

The color of compositions including treated soy protein materials of the present invention is typically such that an aqueous mixture of the composition exhibits a whiteness index of greater than 50, greater than 55, greater than 60, greater than 65, greater than 70, or even greater than 75. Typically, the whiteness index is from 50 to 85, more typically from 60 to 80, still more typically from 65 to 80 and, still more typically, from 70 to 80. In various embodiments, the whiteness index is from 50 to 65, more typically from 50 to 61 and, still more typically, from 50 to 56.

Such whiteness indices are generally observed for aqueous mixtures of treated soy protein-containing compositions containing having a soy protein content of 2 to 3% by weight and a pH of from 6.8 to 7.2.

In various embodiments, the composition containing treated soy protein is in the form of solid (e.g., a free-flowing solid) and an aqueous mixture containing 2 to 3% by weight soy protein is prepared by combining the composition with deionized water to achieve the desired protein content. Additionally or alternatively, the pH of the mixture may be achieved by introduction of an acid or base, as necessary, to adjust the pH of the mixture to a value of 6.8 to 7.2.

In other embodiments, the composition containing treated soy protein is in the form of a liquid and an aqueous mixture having a soy protein content of 2 to 3% by weight is prepared by increasing or decreasing the water content of the liquid composition, as necessary. For example, in the case of a liquid composition containing greater than 3% by weight soy protein, deionized water may be added to the liquid to decrease its soy protein content to a value of 2 to 3% by weight. By way of further example, in the case of a liquid composition containing less than 3% by weight soy protein, the water content of the liquid is reduced to increase its soy protein content to a value of 2 to 3% by weight. The water content of such a composition may be reduced by, for example, drying the composition. Regardless of any adjustment in its water content, a pH of 6.8 to 7.2 may be achieved by introducing an acid or base to the mixture, as necessary.

Aqueous mixtures containing treated soy protein in accordance with the present invention (when having, or when adjusted to, if necessary, a soy protein content of 2 to 3% by weight and a pH of 6.8 to 7.2) typically have whiteness indices of greater than 50 in which the L value is less than 78, less than 75, less than 70, less than 65, or even less than 60. Additionally or alternatively, the b value of such an aqueous mixture is typically less than 9, more typically less than 7.5 and, still more typically, less than 6. In certain embodiments, the b value is from 5 to 9. In other embodiments, the b value of the soy protein-containing composition is typically less than 5, more typically less than 3 and, still more typically, less than 1.

Generally, the whiteness index of an aqueous mixture containing a composition including treated soy protein increases as either or both of solids content or pH of the composition decreases below these levels. At lower solids content (e.g., less than 4% by weight on a protein basis), the concentration of color-causing components, as indicated by the b value, is lowered. Since whiteness index is determined by the expression WI=L−3b, as the b value decreases, the whiteness index increases. At a pH below 6.8, color-causing, low molecular weight components are generally insoluble and tend to precipitate whereas at a pH greater than 7.2 the color-causing, low molecular weight components are soluble and remain in solution where they affect the color of the composition.

The improved color characteristics of the soy protein-containing materials of the present invention are due to a relatively low content of certain non-volatile components and, in particular, a relatively low isoflavone content. Typically, the soy protein-containing composition has a total isoflavone content of less than 500 ppm, less than 300 ppm, less than 200 ppm, less than 100 ppm, less than 90 ppm, less than 80 ppm, less than 50 ppm, less than 25 ppm, or even less than 10 ppm. In certain embodiments, the soy protein-containing composition has a total isoflavone content of from 200 to 300 ppm. Isoflavones present in the soy protein-containing composition are generally selected from (i) aglucone and non aglucone type daidzin, daidzein, genistin, genistein, glycitin, and glycitein isoflavones, and (ii) the malonyl and acetyl esters of aglucone and non aglucone type daidzin, daidzein, genistin, genistein, glycitin, and glycitein isoflavones.

Generally, soy protein-containing materials of the present invention include isoflavones in such a proportion that the weight ratio of soy protein to the combined weight of all isoflavones present in the material is at least 3,000:1, typically at least 5000:1 and, more typically, at least 10,000:1. In various embodiments, the weight ratio of soy protein to the combined weight of all isoflavones present in the composition is at least 20,000:1, at least 40,000:1, at least 100,000:, or even at least 200,000:1.

Reduced inducement of intestinal gas and flatulence in humans by soy protein-containing compositions of the present invention is due to a relatively low content of certain non-volatile carbohydrates (e.g., fructose, glucose, sucrose, maltose, lactose, stachyose, and raffinose). Typically, such compositions contain less than 0.2% by weight of each of these carbohydrates.

Soy protein-containing compositions of the present invention may exhibit various advantageous functional characteristics. For example, these compositions may exhibit advantageous suspendability. To determine the suspendability of the composition, a dispersion or suspension of the composition in a liquid medium (e.g., water) which typically contains 2.5% or 5% by weight solids at pH of from 6.8 to 7.0 is prepared. A predetermined volume of the dispersion or suspension (typically 250 ml) is introduced to and stored in a container for at least 0.5 hours, more typically for from 16 to 24 hours, at temperatures ranging from 4 to 20° C. Generally, the composition separates into various phases or, layers, over the course of the storage time. One such layer includes the portion of the soy protein-containing composition remaining in suspension; formation of any other layers is undesired. One such undesired layer includes a sediment layer at the bottom of the container. The degree or, percent, of suspendability of the composition is determined based on the proportion of the overall volume of the dispersion or suspension introduced to the container which is present in the suspension layer. It has been observed that compositions of the present invention may exhibit supendabilities of greater than 70% (i.e., 70% of the volume of dispersion or suspension introduced to the container is in the suspension layer after storage), more typically greater than 80% and, still more typically, greater than 90%. It is currently believed that such supendabilities are due, at least in part, to a relatively low content of certain low molecular weight peptides and, in particular, a relatively low content of hydrophobic low molecular weight peptides.

Solubility of the proteins contained in the treated compositions is generally determined by preparing a dispersion of the treated composition containing a known quantity of protein, centrifuging the composition to produce a centrifugate, and analyzing the centrifugate to determine its protein content. The amount of protein present in the centrifugate may be determined using various methods generally known in the art and may be determined using a UV-Spectrophotometer. Such methods include, for example, A.O.C.S. (American Oil Chemists' Society) Official Methods Ba 11-65, Revised (1969), Bc 4-91(1997), Aa 5-91(1997), or Ba 4d-90(1997). In accordance with the present invention, at a pH of 7 and a temperature of about 25° C., typically at least 70% of the soy proteins remain in solution after centrifuging the sample, more typically at least 80% and, still more typically, at least 90%.

The solubility of the proteins of a soy protein-containing composition of the present invention may also be expressed in terms of the Nitrogen Solubility Index. NSI as used herein is defined as:
NSI=(% water soluble nitrogen of a protein containing sample/% total nitrogen in protein containing sample)×100

The nitrogen solubility index provides a measure of the percent of water soluble protein relative to total protein in a protein containing material. The nitrogen solubility index of a soy protein material is measured in accordance with standard analytical methods, specifically A.O.C.S. Method Ba 11-65, which is incorporated herein by reference in its entirety. According to the Method Ba 11-65, a soy material sample (5 grams) ground fine enough so that at least 95% of the sample will pass through a U.S. grade 100 mesh screen (average particle size of less than about 150 microns) is suspended in distilled water (200 ml), with stirring at 120 rpm, at 30° C. for two hours; the sample is then diluted to 250 milliliters with additional distilled water. If the soy material is a full-fat material the sample need only be ground fine enough so that at least 80% of the material will pass through a U.S. grade 80 mesh screen (approximately 175 μm), and 90% will pass through a U.S. grade 60 mesh screen (approximately 205 μm). Dry ice should be added to the soy material sample during grinding to prevent denaturation of sample. Sample extract (40 ml) is decanted and centrifuged for 10 minutes at 1500 rpm, and an aliquot of the supernatant is analyzed for Kjeldahl protein (PRKR) to determine the percent of water soluble nitrogen in the soy material sample according to A.O.C.S Official Methods Bc 4-91 (1997), Ba 4d-90, or Aa 5-91, each hereby incorporated by reference in their entirety. A separate portion of the soy material sample is analyzed for total protein by the PRKR method to determine the total nitrogen in the sample. The resulting values of Percent Water Soluble Nitrogen and Percent Total Nitrogen are utilized in the formula above to calculate the nitrogen solubility index.

Soy protein-containing compositions of the present invention typically have a Nitrogen Solubility Index of at least 70%, more typically at least 80% and, still more typically, at least 90%.

Soy protein-containing compositions of the present invention are suitable for use as functional food ingredients in a variety of applications including, for example, meats, including frankfurters, sausages, bologna, ground and minced meats and meat patties, to bind the meat and give the meat a good texture and a firm bite. The compositions may also be used as functional food ingredients in creamed soups, gravies, and yogurts where the soy protein material acts as a thickening agent and provides a creamy viscosity to the food product. Soy protein-containing compositions of the present invention may also be used as functional food ingredients in numerous other food products such as dips, dairy products, tuna, breads, cakes, macaroni, confections, whipped toppings, baked goods and many other applications.

Improved soy protein-containing compositions of the present invention may be prepared using either of the processes described below. One process is a continuous adsorption process and the other is a size exclusion chromatography process.

Continuous Adsorption Process

In one embodiment of a process for preparing an improved soy protein-containing composition of the present invention, a soy protein material is treated with an adsorptive resin selective for the relatively low molecular weight components in a contact vessel. This process is operated continuously, that is, a feed stream composition of a food-grade soy protein-containing material (i.e., the material does not contain a component that is toxic or otherwise biologically hazardous) is fed to the contact vessel while a soy-protein containing product stream is simultaneously removed from the contact vessel. In addition, the contents of the vessel are preferably stirred or otherwise agitated to maintain a dispersion of the adsorptive resin. Advantageously, the use of such a vessel enables treating compositions having a higher solids content and/or higher viscosity while maintaining low pressures in the contact vessel; this provides an advantage, for example, over adsorption processes which require relatively high pressures to treat a composition having these characteristics (e.g., relatively high solids content and viscosity) in a packed adsorption column. Avoiding high pressures in the contact vessel generally increases process efficiency.

Advantageously, this process is compatible with feed streams having a wide range of viscosities. In general, the process may be used with a feed stream which is capable of being pumped which, generally, includes feed streams having a viscosity of up to 650 centipoise. Typically, however, the feed stream will have a viscosity of at least 70 centipoise, and, more typically, from 70 to 650 centipoise. For example, feed streams containing a soy protein concentrate or a soy protein isolate will typically have a viscosity of no more than 650 centipoise and, more typically, from 100 to 650 centipoise. In general, the term viscosity refers to the apparent viscosity of a slurry or a solution as measured with a rotating spindle viscometer utilizing a large annulus, where a particularly preferred rotating spindle viscometer is a Brookfield viscometer. The apparent viscosity of a soy protein material may be measured, for example, by weighing a sample of the soy material and water to obtain a known ratio of the soy material to water (preferably I part soy material to 7 parts water, by weight), combining and mixing the soy material and water in a blender or mixer to form a homogenous slurry of the soy material and water at a temperature of about 20° C. and pH of 7, and measuring the apparent viscosity of the slurry with the rotating spindle viscometer utilizing a large annulus, operated at approximately 30 to 60 revolutions per minute (rpm) and at a torque of from 30 to 70%.

If desired, the volatile component content of the feed stream of this process may be reduced prior to its introduction into the contact vessel by heat treatment or other suitable means. For example, the material may be heated to a temperature of 150° C. (from 300 to 305° F.) for a period of from 9 to 15 seconds. Removal of volatile components in this manner tends to decrease the load of volatile components to be removed in the contact vessel to provide a product having the desired flavor, odor, appearance, or functionality. Heat treatment also destroys microorganisms present in the composition which is desirable since soy protein-containing compositions of the present invention are typically incorporated into functional food ingredients.

The soy protein-containing composition may be contacted with an enzyme in order to reduce its viscosity. Suitable enzymes include protease enzymes which hydrolyze proteins in the soy protein-containing composition.

Regardless of the form of the soy-protein containing material, the feed stream of this process typically contains no more than 25% by weight solids. Typically the composition contains from 5 to 20% by weight solids and, more typically, from 5 to 15% by weight solids. If desired, the solids content of the feed stream may optionally be reduced before it is introduced into the contact vessel. For example, to refine the composition, the feed stream may be centrifuged or filtered to separate the soy protein from other components.

In certain embodiments of this process, the soy protein material in the composition to be treated comprises varying amounts of minerals (e.g., calcium, phosphorus, potassium, and sodium). Generally, the soy protein material may contain a mineral content of greater than 5% by weight, greater than 7.5% by weight, or even greater than 10% by weight. Typically, the mineral content is from 4 to 12% by weight. In one embodiment, a soy protein concentrate comprises up to 4% by weight calcium, up to 3% by weight phosphorus, up to 2% by weight potassium, and up to 2% by weight sodium. Typically, at least about 90%, on a weight basis, of the minerals present in the feed soy protein-containing composition is present in the treated soy protein-containing composition and, more typically, at least about 95%. Mineral content of feed and treated composition may be determined using inductively coupled plasma atomic emission spectroscopy in accordance with Official Methods of Analysis of the AOAC (1995) 16th Ed., Methods, 965.09, Locator #2.6.01; 968.08, Locator #4.8.02; and 984.27, Locator #50.1.05 (Modified). This method is also described in Inductively Coupled Plasma Atomic Emission Spectroscopy, An Atlas of Spectral Information, Winge et al., Elsevier, N.Y. (1985).

Regardless of the type of soy protein material contained therein, the pH of the feed stream is typically 6 to 8 and, more typically, from 6.5 to 7 to maintain the soy proteins in solution.

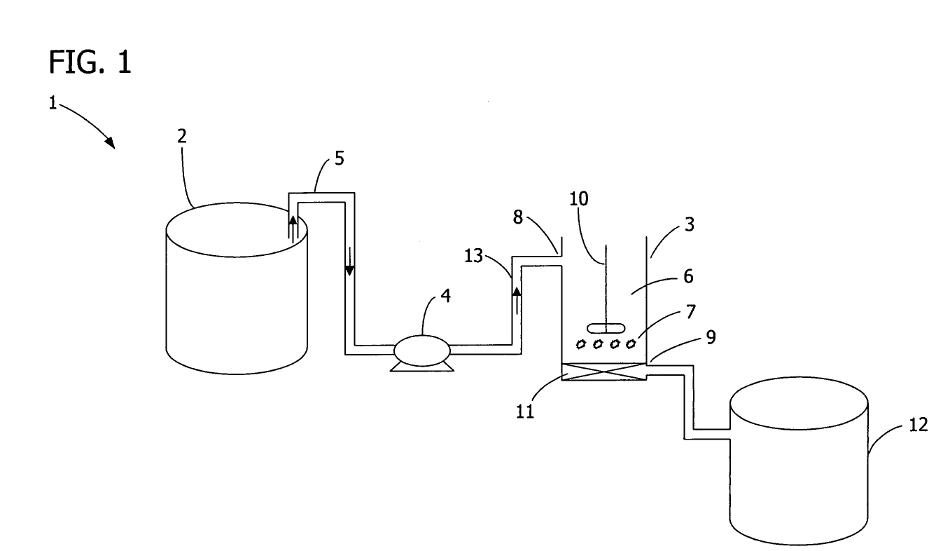

Referring now to FIG. 1, the flavor, odor or appearance of a soy protein-containing material may be improved in accordance with this process using apparatus 1. Soy protein-containing composition to be treated is transferred from feed reservoir 2 to contact vessel 3 by means of pump 4 and piping 5. In contact vessel 3, the soy protein-containing composition contacts adsorbent resin 7 which selectively adsorbs flavor, odor or appearance-affecting components from the composition. The treated soy protein-containing composition exits contact vessel 3 via outlet 9 and is collected in product tank 12.

Generally, the contact vessel 3 includes an inlet 8, an outlet 9, an adsorbent resin 7, an agitator 10, an agitated adsorption zone 6, and filter medium 11. The inlet 8 to the contact vessel 3 is in fluid flow communication with pump 4 and feed tube 13 in order to supply the feed composition to the contact vessel 3. Feed composition is introduced to the inlet 8 via feed tube 13 and enters the contact vessel 3 to be contacted with adsorbent resin 7 within the agitated adsorption zone 6. Treated soy protein-containing composition exits the contact vessel 3 by passage through filter medium 11 and the contact vessel outlet 9. Outlet 9 is in fluid flow communication with suitable means for collection of treated soy protein-containing composition. Suitable means for collection of treated soy protein-containing composition include product tanks constructed of chemically resistant materials. The material of construction and configuration of such product tanks are not narrowly critical.

Feed reservoir 2 and pump 4 may be constructed of any of a variety of chemically resistant materials including, for example, stainless steel, glass, and plastics such as polypropylene and polyethylene. The capacity, shape and other design criteria are not critical to the invention and will vary depending upon the type and source of the soy protein-containing composition and other process constraints.

Adsorbent resin 7 contained in the contact vessel 3 is generally in particulate form and is selective toward the low molecular weight components present in the feed composition to be removed from the soy protein. Generally, commercial, food-grade resins having certain desired characteristics (e.g., particle size and pore size) are selected to separate the protein and low molecular weight components. The resin may comprise ionic exchange resins, including anionic exchange resins and cationic exchange resins, adsorbent resins, and mixtures thereof. Adsorbent resins are generally preferred since it has been observed that this type of resin may provide greater removal of volatile and nonvolatile components as compared to other types. Additionally or alternatively, adsorbent resins may be preferred because they exhibit little or no ion exchange functionality. Due to such ion exchange functionality, significant amounts of minerals are not removed from compositions treated using adsorbent resins. Accordingly, adsorbent resins are often preferred when mineral-containing products are desired. Generally, the adsorbent resin complies with applicable regulations required to be food grade (e.g., 21 C.F.R. 173.25 and 21 C.F.R. 173.65).

Exemplary adsorbent resins include polymeric adsorbents and carbonaceous adsorbents. Typically the resin comprises a polymeric adsorbent and, more typically, a polymeric adsorbent based on crosslinked polymers formed from monomers selected from the group consisting of aromatic monomers, aliphatic monomers, or mixtures thereof. Suitable aromatic monomers include phenol, styrene, and alkyl-substituted styrenes such as -methylstyrene, ethylvinylbenzene, p-methylstyrene, and vinylxylene and suitable aliphatic monomers include acrylic esters, methacrylic esters, and acrylonitrile. Typically, the polymers are crosslinked with polyethylenically unsaturated monomers including, for example, aromatic crosslinkers such as divinylbenzene, divinyltoluene, trivinylbenzene, divinylchlorobenzene, diallylphthalate, dinvylnapthalene, divinylxylene, divinylethylbenzene, trivinylnapthalene and polyvinylanthracenes; aliphatic crosslinkers having a plurality of non-conjugated vinyl groups such as di- and polyacrylates and methacrylates (for example, trimethylpropane trimethylacrylate, ethylene glycol dimethylacrylate, ethylene glycol diacrylate, neopentyl glycol dimethacrylate, pentaerythiol tetra- and trimethylacrylates and allyl acrylate; divinylaliphatic crosslinking monomers such as divinyl ketone and diethylene glycol divinyl ether; diacrylamides and dimethylacrylamides such as N′,N′-methylenediacrylamide, N′,N′-methylenedimethacrylate, and N′,N′-ethylenediacrylamide; polyallyl aliphatic crosslinkers such as diallyl malleate, diallyl fumarate, diallyl succinate, diallyl carbonate, diallyl malonate, diallyl oxalate, diallyl adipate, diallyl sebacate, diallyl tartrate, diallyl tricarballylate, triallyl aconitate, and triallyl citrate; and the polyallyl and polyvinyl ethers of glycol, glycerol, and pentaeryythriol. In a preferred embodiment, the adsorbent comprises styrene and divinylbenzene. Typically, the adsorbent resin is crosslinked to provide a stable resin under the process conditions, more typically at least 2% crosslinked and, still more typically, at least 4% crosslinked.

Adsorbent resins having a range of pore and particle sizes may be used in accordance with this process. Generally, pore sizes ranging from 50 to 100 Å are preferred. Typically, the pore size will be 65 to 100 Å. In general, the resin will have a minimum particle size of 300 μm. Typically, the particle size of the resin is 300 to 800 μm, more typically from 300 to 650 μm and, still more typically, from 300 to 400 μm. Ion exchange resins suitable for use in this process typically have a particle size of from 300 to 900 μm.

The surface area of the adsorptive resin, measured in accordance with the Brunauer-Emmett-Teller method, is typically 700 m²/g and, more typically, from 700 to 800 m²/g. Exemplary commercially available resins include Amberlite XAD-16HP manufactured by Rohm and Haas (Philadelphia, Pa.); Sepabeads SP-70, Diaion EX CO4, Diaion PA 308, Diaion SA 11A, and Diaion WA 30 manufactured by Mitsubishi Specialty Chemicals (now Itochu Specialty Chemicals, Inc.) (Carmel, Ind.); and Optipore SD-2 Dowex resins manufactured by Dow Chemicals (Midland, Mich.).

Typically, the contact vessel contains at least 0.2 liters of resin per liter of capacity of the vessel and, more typically, from 0.2 to 0.6 liters of resin per liter of capacity of the vessel.

Treated soy protein-containing material is removed from the contact vessel by passage through the filter medium 11 and outlet 9. The filter medium may be constructed of materials selected from the group consisting of chemically resistant materials such as stainless steel and polyetheretherketone (PEEK). In one embodiment of the process, the filter medium is constructed of stainless steel and, in another, polyetheretherketone. The filter medium 11 is selected to allow treated soy protein-containing composition to exit the contact vessel while retaining the resin in the adsorption zone. Thus, the pore size of the filter is not greater than the minimum particle size of the resin. Generally, the pore size of the filter is at least 250 μm and, more typically, at least 300 μm. Typically, the pore size of the filter is from 250 to 350 μm and, more typically, from 300 to 350 μm. Suitable commercial filters include filters constructed of polyetheretherketone and manufactured by Sefar America, Inc. (Depew, N.Y.).

Contact vessel 3 includes agitator 10 to produce an agitated adsorption zone 6 within the contact vessel; in this zone, the agitator induces movement of the resin as well as the soy protein composition. In general, the degree of agitation is preferably sufficient to promote a substantially uniform dispersion of the resin in the soy protein composition but insufficient to cause the formation of a vortex. Selection of a resin having a density near that of the aqueous medium promotes uniform mixing and, thus, the desired degree of agitation. Accordingly, the density of the resin is preferably from 1.0 to 1.1 and, more typically, from 1 to 1.05 g/cm³.

Feed soy protein-containing composition containing a soy protein material and low molecular weight components is introduced into contact vessel 3, as a treated aqueous protein composition containing soy protein and having a relatively reduced content of low molecular weight components is simultaneously removed from the contact vessel. The flow rate into and out of the contact vessel is generally controlled to allow sufficient time for contact between the feed composition and the resin to ensure removal of a sufficient amount of low molecular weight components, taking into account the volume of the contact vessel and the quantity and capacity of resin in the adsorption zone. Residence time, calculated as the number of bed volumes of soy protein material per hour with 1 bed volume being equivalent to passage of 1 m³ of soy protein composition through 1 m³ of resin, is one convenient measure of contact time. When determined on this basis, the residence time is preferably less than 17 bed volumes/hour, more preferably less than 10 and, still more preferably, is less than 6 bed volumes per hour. Typically, the residence time is from 1 to 6 and, more typically, from 2 to 3 bed volumes per hour.

Simultaneous introduction of soy protein-containing composition to the contact vessel and removal of treated soy protein-containing composition therefrom provide advantages as compared to conventional processes carried out in a packed (stationary) bed. In particular, this process may be used to treat feed soy protein compositions having relatively high solids content or relatively high viscosity while avoiding the problems associated with column fouling which would typically be experienced in a packed bed. Column fouling is typically caused by collection of large molecular weight proteins, either alone or in combination with other components of the soy protein materials (e.g., fats and oils), on or within the resin bed and requires discontinuing the process to clean the column and regenerate the resin. Thus, this process reduces process downtime related to column cleaning and resin regeneration. Simultaneous introduction of soy protein-containing composition to the contact vessel and removal of treated soy protein-containing composition therefrom also provides increased productivity due to the higher throughput capabilities of the continuous process compared to a batch chromatography process.

In accordance with this process for preparing improved soy protein-containing compositions of the present invention which includes introduction of feed composition to the contact vessel and simultaneous removal of treated composition therefrom, the pressure drop observed between the inlet 8 and outlet 9 of the contact vessel is generally low. Typically, the pressure drop between the inlet and outlet of the contact vessel is no more than 5 psig (0.35 bar), more typically no more than 2.5 psig (0.15 bar) and, still more typically, no more than 1 psig (0.05 bar). In certain embodiments in which the composition to be treated primarily contains particles having a size up to 300 μm, the process operates without any noticeable generation of pressure drop between the inlet and outlet. Operation of this process at low pressures contributes to the overall benefits of this process described above including, for example, avoiding the problems associated with column fouling often observed when using a packed bed.

Soy protein-containing compositions may contain significant amounts of partially denatured soy protein. As noted above, soy protein in its native state is a globular protein having a hydrophobic core surrounded by a hydrophilic shell. Native soy protein is very soluble in water due to its hydrophilic shell. The partially denatured soy proteins in soy protein-containing compositions have been partially unfolded and realigned so that hydrophobic and hydrophilic portions of adjacent proteins may overlap. The partially denatured soy proteins, however, have not been denatured to such an extent that the proteins are rendered insoluble in an aqueous solution. In an aqueous solution, the partially denatured soy proteins of the soy material may form large aggregates wherein the exposed hydrophobic portions of the partially denatured proteins are aligned with each other to reduce exposure of the hydrophobic portions to the solution. These aggregates generally promote the formation of gels, increase gel strength, and increase viscosity of the soy material. In certain embodiments, such aggregation occurs among proteins having a molecular weight of approximately 800 kilodaltons. Advantageously, this process in which the adsorptive resin is free-flowing allows for treating soy protein-containing compositions exhibiting such aggregation and, accordingly, providing treated soy protein-containing compositions exhibiting such aggregation. In particular, it has been observed that feed soy protein-containing compositions which have not been heat treated prior to resin treatment exhibit further aggregation after resin treatment.

Generally, flow through the contact vessel continues until a break-through point with respect to one or more types of the low molecular weight components is reached at which time the resin is cleaned and regenerated. Break-through point generally refers to the point at which the resin becomes saturated with one or more types of low molecular weight components by passage of the soy protein-containing composition through the contact vessel. The resins typically have multiple break-through points depending on the various types of low molecular weight components present in the soy protein-containing composition being treated. Typically, the resin reaches a break-through point with respect to volatile components (e.g., flavor-causing or odor-causing components) after passage through the contact vessel of at least 0.5 kg of soy protein-containing composition per kg of resin and, more typically, at least 1.0 kg of soy protein-containing composition per kg of resin. However, the break-through point with respect to non-volatile components (e.g., color-causing components) is typically not reached until greater than 1 kg of soy protein-containing composition per kg of resin passes through the contact vessel. It has been observed that from 1 kg to 5 kg of soy protein-containing composition per kg of resin may typically pass through the contact vessel before the break-through point with respect to non-volatile components is reached and, more typically, from 2 kg to 4 kg of soy protein-containing composition per kg of resin may typically pass through the contact vessel before the break-through point with respect to non-volatile components is reached. Break-through points may also be determined by monitoring one or more characteristics of the treated composition. The break-through points are generally reached when one or more characteristics of the treated composition (e.g., flavor, odor, or whiteness index) reach a predetermined level and/or are no longer improving. For example, the whiteness index of the treated composition may be monitored to determine when its whiteness index is below a certain level (e.g., 50), after which time the process is discontinued. The decrease in whiteness index thus indicating that the resin is no longer removing a sufficient proportion of the low molecular weight components. Operation of the process in this manner ensures that a mixture of previously collected treated samples will produce a composition exhibiting a whiteness index above 50.

The feed and treated soy protein-containing compositions of this process may be heat-treated (e.g., heated to a temperature of 150° C. (from 300 to 305° F.) for a period of from 9 to 15 seconds) prior to and/or after resin treatment. In certain embodiments, heat treatment after resin treatment provides treated compositions having higher viscosity and/or gel or emulsion strength than heat-treated, non-resin treated compositions. Thus, resin treatment followed by heat treatment increases the viscosity of the soy protein-containing composition. Heat treatment after resin treatment without heat treatment prior to resin treatment typically provides an increase in viscosity as compared to heat treated, non-resin treated soy protein compositions of at least 50% and, more typically, at least 55% (e.g., viscosity of the soy protein-containing composition will be increased from 100 centipoise to 150 or 155 centipoise).

Lower viscosity soy protein-containing compositions may be desired for use as functional food ingredients for liquid products (i.e., beverages) whereas higher viscosity compositions may be desired when the intended applications for the composition include incorporation into a meat product. Thus, in certain embodiments, the soy protein-containing composition introduced to the contact vessel may be selected based on the desired viscosity of the treated soy protein-containing composition. That is, depending on the desired viscosity of the treated composition and viscosity of the feed composition, heat treatment prior to and after resin treatment may be incorporated if a reduction in viscosity is necessary to reach the desired viscosity. Similarly, if an increase in viscosity is necessary to reach the desired viscosity, heat treatment prior to resin treatment is avoided and the lone heat treatment operation is carried out after resin treatment.

In certain embodiments, functional food ingredients (e.g., hot dogs) containing treated soy protein-containing compositions treated in accordance with this process exhibit improved gel or emulsion strength, compression hardness, and chewiness. Such characteristics are typically observed for functional food ingredients containing treated soy protein-containing compositions which have been heat-treated after resin treatment but not prior to resin treatment, as described above. It is currently believed that such improvements are due, at least in part, to the removal of low molecular weight peptides and/or aggregation of larger molecular weight proteins. Emulsion strength, compression hardness, and chewiness are expressed in terms of grams and may be determined using a TA.TXT2 Texture Analyzer, manufactured by Stable Micro Systems Ltd. (England). Improvements in emulsion strength of functional food ingredients containing soy protein-containing compositions treated in accordance with this process of greater than 5%, greater than 10%, or even greater than 15% have been observed. Typically, the improvement in emulsion strength is from 5% to 25%, more typically from 10% to 25% and, even more typically, from 15% to 25%. Improvements in compression hardness of functional food ingredients containing soy protein-containing compositions treated in accordance with this process of greater than 5% have been observed. Typically, the improvement in compression hardness is from 5% to 10%. Improvements in chewiness of functional food ingredients containing soy protein-containing compositions treated in accordance with this process of greater than 10% have been observed. Typically, the improvement in chewiness is from 10% to 20%.

In other embodiments of this process, heat treatment prior to and after resin treatment provides treated compositions having lower viscosity and/or gel or emulsion strength than heat treated, non-resin treated compositions. Thus, in addition to reducing volatile component content and destroying microorganisms as described above, heat treatment prior to and after resin treatment reduces the viscosity of the treated soy protein-containing composition. Typically, heat treatment prior to and after resin treatment provides a reduction in viscosity as compared to heat treated, non-resin treated soy protein compositions of at least 20% and, more typically, of at least 25% (e.g., viscosity of the soy protein-containing composition will be decreased from 100 centipoise to 80 or 75 centipoise).

The resin may be cleaned and regenerated to allow the resin to be used to treat multiple feed compositions, thus providing an important economic benefit to the overall process. Generally, the resin is contacted with 2 to 3 bed volumes of one or more chemicals (e.g., sodium chloride, sodium hydroxide, sodium bicarbonate, or hydrogen peroxide) to clean the resin followed by one or more water washings to remove the chemicals from the resin. When a base such as sodium hydroxide is used to clean the resin, the resin is also generally contacted with an acid to neutralize the resin. Suitable washing methods for cleaning and regenerating the resin include those known generally in the art.

Hydrogen peroxide may be used to clean the resin alone or in combination with other chemicals and may increase the rate of cleaning because contacting hydrogen peroxide with the resin produces an active free radical which cleans the resin. In particular, it is currently believed that hydrogen peroxide is well-suited for removal of polysaccharides, oils, fats, and gums from the resin.

Sodium bicarbonate may be incorporated into cleaning protocols including other chemicals or may be the lone chemical used. In addition to cleaning the resin, it is currently believed that resins cleaned with sodium bicarbonate may produce treated soy protein-containing compositions having reduced off flavor as compared to resins cleaned using other chemicals. This is currently believed to be due to sodium bicarbonates capacity for absorbing odors, thus producing a relatively odor-free resin. In addition, in certain instances sodium bicarbonate may be preferred for cleaning the resin since it is a relatively mild chemical as compared to, for example, sodium hydroxide.

Suitable washing methods for cleaning and regenerating the resin include, for example, contacting the resin with approximately 2 to 3 bed volumes of ethanol followed by contacting the resin with approximately 2 to 3 bed volumes of water. In certain embodiments, contacting the resin with either or both of ethanol and water may be repeated. Such a method may also include ethanol washing followed by water washing and further includes contacting the resin with 2 to 3 bed volumes of a salt (e.g., sodium chloride) after water washing, followed by further water washing. In certain embodiments, including the salt washing step provides increased regeneration of the resin. It is currently believed that in addition to contributing to cleaning of the resin, contacting the resin with ethanol elutes certain low molecular weight components bound to the resin including, for example, certain bioactive peptides, polyphenols, and isoflavones. Recovery of such low molecular weight components is desired in certain instances due to the phytochemical and nutraceutical utility of such components.

Another suitable method includes contacting the resin with approximately 2 to 3 bed volumes of a base (e.g., sodium hydroxide) to clean the resin, contacting the resin with approximately 2 to 3 bed volumes of an acid (e.g., hydrochloric acid) to neutralize the resin, followed by contacting the resin with approximately 2 to 3 bed volumes of water. In certain embodiments, contacting the resin with 2 to 3 bed volumes of water may be repeated. In addition, one or more water washings may be included between washing with the base and washing with the acid. One suitable variation of this method includes, prior to contacting the resin with the base, one or more water washings and contacting the resin with 2 to 3 bed volumes of hydrogen peroxide.

Another suitable method includes contacting the resin with 2 to 3 bed volumes of a mixture of sodium bicarbonate and sodium chloride, followed by contacting the resin with 2 to 3 bed volumes of water one or more times, contacting the resin with 2 to 3 bed volumes of an acid (e.g., hydrochloric acid), followed by contacting the resin with 2 to 3 bed volumes of water. The final washing step may be repeated one or more times.

An additional method includes an initial water washing step, followed by hydrogen peroxide washing and another water washing step followed by contacting the resin with 2 to 3 bed volumes of a mixture of sodium bicarbonate and sodium chloride. After this step, the resin is washed with 2 to 3 bed volumes of water, followed by contacting with 3 to 4 bed volumes of phosphoric acid and one or more water washings.

The water washing steps remove the chemicals used to clean the resins to avoid the chemicals affecting subsequent performance of the resin. For example, residual sodium hydroxide may cause an undesired off flavor of the composition contacted with a resin cleaned with sodium hydroxide; residual hydrochloric acid may cause incorrect whiteness index measurements by reducing the pH of a composition contacted with a resin cleaned with hydrochloric acid. Contacting the resin with water after contacting with the cleaning chemicals is generally suitable to avoid these problems. But in certain instances water (generally 5 to 6 bed volumes) may be passed through a contact vessel to which the cleaned and regenerated resin has been re-introduced.

Some filter materials may be affected by the reagents used for cleaning and regenerating the resin; typically, however, the filter will not be affected by contact with materials used to clean the resins (e.g., bases such as sodium hydroxide and acids such as hydrochloric acid) and the temperatures (e.g., up to 90° C.) of the materials which contact the filter during cleaning operations.

Size Exclusion Chromatography Process

In another embodiment of a process for preparing an improved soy protein-containing composition of the present invention, a soy protein material is treated with a size exclusion resin selective for the relatively low molecular weight components in a column.

This process includes feeding a food-grade soy protein-containing material (i.e., the material does not contain a component that is toxic or otherwise biologically hazardous) to a chromatographic separation zone which includes a bed of a size exclusion resin comprising porous particles and having a size exclusion limit. The food-grade material is passed through the resin to reduce the concentration in the composition of components having a molecular weight less than the size exclusion limit of the resin. After passing through the bed of size exclusion resin, the composition is eluted from the chromatographic zone.

The soy protein-containing composition feed material may be the product or offstream from another operation or process, such as the preparation of soy flakes, soy flour, soy grits, soy meal, soy protein concentrates, or soy protein isolates. In general, however, the feed stream preferably contains no more than 20% by weight solids and, more preferably, no more than 15% by weight solids. Typically, the composition contains from 5 to 20% by weight solids and, more typically, from 10 to 15% by weight solids. The solids present in the soy protein-containing composition to be treated generally include soy fiber and fat components.

In certain embodiments, it may be preferred to remove most if not all of the solid components present in the feed composition prior to treatment to reduce the risk of column fouling. The composition may be subjected to one or more pre-treatment operations including, for example, filtration or centrifuging. The particle size of the undesired solids present in the composition typically range up to 20 to 25 μm. Typically, filtration of the soy protein-containing composition prior to treatment comprises passing the composition through a filter medium, thus, in certain embodiments, the filter medium used for filtration of the soy protein-containing composition has a particle retention of between 20 and 25 μm. Typically, the filter medium is constructed of chemically resistant materials including, for example, stainless steel, plastic, and ceramic. Suitable commercial filters include a No. 4 Whatman manufactured by Whatman Inc. (Clifton, N.J.). In the case of a soy protein-containing composition containing a soy protein material less refined than a soy protein isolate (i.e., soy flakes, soy flour, soy grits, soy meal, and soy protein concentrates), it may be preferred to subject the composition to centrifuging to remove undesired particulate solids. The conditions of a centrifuging operation vary depending on numerous factors including, for example, the solids content of the soy protein-containing composition and the desired solids content of the treated soy protein-containing composition. Typically, the soy protein-containing composition is centrifuged for at least 20 minutes per kg of solids present in the composition and the centrifuging operation typically reaches at least 2600 revolutions per minute (rpm).

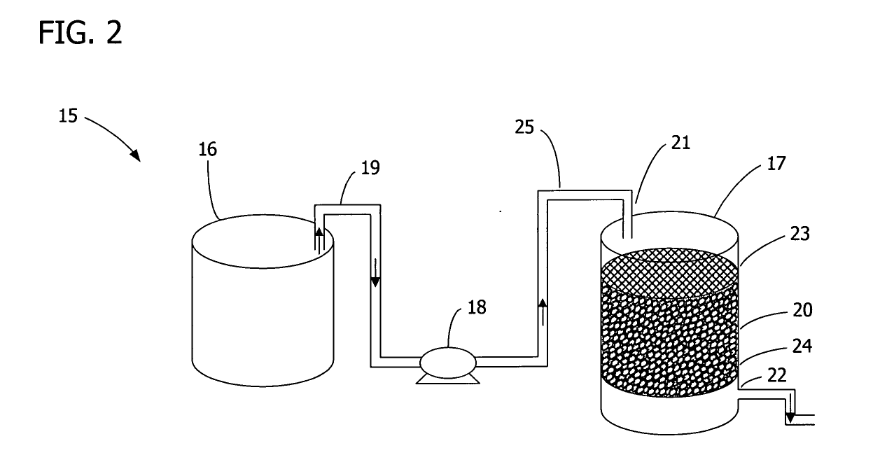

As shown in FIG. 2, the soy protein-containing material may be treated by the present process using apparatus 15. Soy protein-containing composition to be treated is transferred from a source, such as a feed reservoir 16 to column 17 by means of a pump 18 and piping 19. In column 17, the soy protein-containing composition contacts a bed of chromatographic material containing a size exclusion resin 20 selective for removal of low molecular weight components from the composition.

Generally, the column 17 includes an inlet 21, an outlet 22, and filters 23 and 24. The inlet 21 to the column is in fluid flow communication with pump 18 and piping 19, including feed tube 25, to supply the composition to column 17. Treated soy protein-containing composition exits column 17 after passing though filter 24 and column outlet 22. Column outlet 22 is in fluid flow communication with suitable means for collection of treated soy protein-containing composition or further treatment.

The soy protein-containing composition may be fed to the inlet 21 of column 17 by any suitable means including, for example, a pump 18 in fluid flow communication with feed reservoir 16 or may be gravity fed to the column. The type of pump used to introduce the composition to the inlet of the column is not narrowly critical however it preferably provides a highly stable, precisely measured and programmed flow of the soy protein-containing composition through the inlet to the column. A variety of pumps are known for use in chromatographic systems such as constant flow rate pumps, reciprocating pumps, positive displacement (i.e., syringe) pumps and constant pressure pumps. A filter placed in line below the pump may be used as well as a pressure gauge to monitor the pressure in the system.

Feed reservoir 16 and column 17 are preferably constructed of any of a variety of chemically resistant materials such as stainless steel, glass, and synthetic resin materials including, for example, polyethylene, polypropylene, and poly ether ether ketone. The column is typically cylindrical and both the length, diameter, and ratio of the length to the diameter may vary widely. The capacity of the column may also vary widely and typically depends on the overall amount of soy protein-containing composition to be treated, the volumetric flow rate of the soy protein-containing composition introduced to the column, or the bed of chromatographic material to be contained in the column.

As shown in FIG. 2, the column includes filters 23 and 24 at each end of the column having a mesh or pore size which prevents loss of resin from the column. Typically, the pore size of the filters is from 20 to 60 μm and, more typically, from 20 to 40 μm. The filters 23 and 24 may be constructed of materials selected from the group consisting of stainless steel, glass, and polymeric materials such as polyethylene and polytetrafluoroethylene.

To enable the treated soy protein-containing materials of the present invention to be used as functional food ingredients, the resin used in this process preferably complies with the applicable regulations (e.g., 21 C.F.R. §173.25 and 21 C.F.R. §173.65) governing resins used in the preparation of “food-grade” compositions. Such resins include, for example, resins comprising methyl methacrylates, dextrans, agarose, and various silicas. Exemplary commercial resins include Sephacryl (S-100 HR) resins manufactured by Supelco (Bellefonte, Pa.); Toyopearl HW series methyl methacrylate resins (e.g., 40F, 40S, 50F, 50S, 55F, 55S, 60F, 60S, 65F, 65S, 75F, and 75S) manufactured by Supelco (Bellefonte, Pa.); TSKgel type silica resins manufactured by Tosoh Biosciences (Montgomeryville, Pa.); SuperDEX dextran resins manufactured by Amersham Biosciences (Piscataway, N.J.); and Superose agarose resins manufactured by Amersham Biosciences (Piscataway, N.J.).

In general, the pore size of the resin affects the selectivity of the resin for low molecular weight components in the soy protein-containing composition; soy proteins are generally excluded from pores of the resin while the low molecular weight components are able to enter the pores, thus leading to a greater retention time for the low molecular weight components and elution of a mixture of soy proteins having a reduced low molecular weight component content from the column. Typically, the pore size of the resin is at least 50 Å, more typically at least 125 Å and, still more typically, at least 500 Å. Typically, the pore size of the resin is from 50 to 2000 Å, more typically from 50 to 100 Å and, still more typically, from 100 to 500 Å.

The range of molecular weights of the components excluded by the size exclusion resin based on its pore size is referred to as the fractionation range. The upper limit of the fractionation range indicates the largest molecules in terms of molecular weight able to enter the pores of the resin and, thus, the largest molecules to be separated from the proteins by size exclusion (i.e., molecules greater in size are excluded from the resin); this upper limit is commonly referred to as the size exclusion limit of the resin. The ability of a molecule of a certain molecular weight to enter the pores of the resin and, thus, be separated from the soy proteins, is currently believed to be due at least in part to the shape of the molecule. This is believed to be due to the effect of the shape of the molecule on its radius of gyration which generally determines the size of pores a molecule is able to enter and which may generally be expressed as proportional to Ms where M is the molecular weight of the molecule and s varies depending on the shape of the molecule. For example, for rod-shaped molecules s generally equals 1, for flexible coil-shaped molecules s generally equals 0.5, and for spherical molecules s generally equals 0.33. Thus, as compared to rod shaped molecules, flexible coil-shaped molecules having higher molecular weights may be able to enter the pores of a resin. In addition, as compared to both rod shaped and flexible coil-shaped molecules, higher molecular weight spherical molecules may be able to enter the pores of a resin. Depending on the composition to be treated and the resin selected, the size exclusion limit may range up to 700,000 daltons, up to 800,000 daltons, up to 5,000,000 daltons, or up to 50,000,000 daltons. The fractionation range may vary below the size exclusion limit. Exemplary fractionation ranges include those ranging from 1000 to 700,000 daltons, from 500 to 800,000 daltons, and from 100 to 100,000 daltons. In various embodiments, the resin has a size exclusion limit of S in which S is no more than 50,000 daltons and components of the soy protein material having a molecular weight less than S are retained by the resin and components having a molecular weight greater than S are not retained by the resin.

In addition to pore size of the resin and the attendant fractionation range and size exclusion limit, the particle size of the resin may also be taken into consideration. It has been observed that removal of the low molecular weight components from the soy protein-containing material may improve as the particle size of the resin decreases. This is presently believed to be due to the increase in surface area of resin exposed to the soy protein-containing composition as the particle size of the resin decreases.

In certain embodiments of this process for preparing treated soy protein-containing compositions of the present invention, the particle size of the resin is no more than 60 μm. In such embodiments, the particle size of the resin is generally from 20 to 60 μm or from 30 to 60 μm. In other embodiments, the particle size of the resin is no more than 40 μm. In such embodiments, the particle size of the resin is generally from 20 to 40 μm.

In one preferred embodiment of this process, the resin has a pore size of 500 Å, a fractionation range of from 1000 to 700,000 daltons, and the particle size of the resin is from 20 to 40 μm.

In general, the column comprises the bed of size exclusion resin and the chromatographic separation zone, each occupying all or a portion of the column. The bed of size exclusion resin may be prepared by introducing the resin to the column in accordance with standard packing techniques including, for example, dry packing, wet packing, slurry packing, or downflow or upflow packing methods. The characteristics of the bed of size exclusion resin (e.g., length, volume, density) may depend on numerous factors including, for example, the overall amount of soy protein-containing composition to be treated, the rate of introduction of the soy protein-containing composition to the column, the protein content of the soy protein-containing composition, and the solids content of the soy protein-containing composition. Typically, the column contains a resin height of at least 1 cm of resin per gram of solids in the soy protein-containing composition feed and, more typically, at least 2 cm of resin per gram of solids in the feed.

The amount of resin, or, bed of chromatographic material may be expressed in terms of the amount of resin contained in the column determined based on the length of the bed of chromatographic material and the diameter of the column (i.e., resin bed volume). Thus, while the length and diameter of the column are not narrowly critical, the dimensions of the column are generally selected to provide space for a suitable bed volume. The ratio of the length of the column to its diameter is typically at least 2:1, more typically at least 5:1 and, still more typically, from 10:1 to 20:1.

The flow rate through the bed of chromatographic material generally allows time for sufficient contact between the feed composition and the resin to ensure removal of a sufficient amount of low molecular weight components. Typically, the soy protein-containing composition passes through the bed of chromatographic material at a rate of at least 0.05 liters per hour per unit m² cross sectional area of the bed.

Taking into account the desired flow rate of the soy protein-containing composition, the volume of the resin bed is preferably selected to provide sufficient contact time for the resin to significantly reduce the content of low molecular weight components in the composition. Typically, no more than <0.25 (25% resin bed volume) m³ of soy protein-containing composition per m³ resin bed volume are introduced to the column, more typically no more than <0.20 m³ of soy protein-containing composition per m³ resin bed volume and, still more typically, no more than 0.15 m³ of soy protein-containing composition per m³ resin bed volume.

In one embodiment of this process, the soy protein-containing composition may be treated by passage through two or more of columns or cartridges arranged in series. Alternatively, the soy protein-containing composition may be treated by passage through two or more of columns or cartridges arranged in parallel; in this arrangement, one or more cartridges or columns may be used to treat the composition while one or more cartridges or columns is being regenerated.

By selecting a size exclusion resin having a size exclusion limit below the molecular weight of the soy proteins in the feed composition of interest, these proteins are allowed to pass through the bed of size exclusion resin while low molecular weight components which contribute undesired characteristics are retained. Soy protein-containing compositions typically contain two or more soy proteins having a molecular weight in excess of 50,000 daltons and, since they are not retained by the size exclusion resin, the relative amount of these proteins in the feed and treated product does not substantially change. Stated another way, the relative proportions of any two soy proteins having a molecular weight of 50,000 daltons in the treated product does not vary significantly from the relative proportions of these proteins in the feed composition. In one embodiment, the relative proportion (on a weight ratio) does not vary by more than 20%. More preferably, the relative proportion (on a weight ratio) does not vary by more than 10%. Still more preferably, the relative proportion (on a weight ratio) does not vary by more than 5%. By way of example, if a feed composition comprises soy proteins, A, B, and C, each having a molecular weight greater than 50,000 daltons, the weight ratio of each these proteins to the others (i.e., the weight ratio of A:B, A:C, and B:C in this example) in the treated composition is within 20% of the weight ratio of each such pair, respectively, in the feed composition. Thus, for example, if the weight ratio of protein A to protein B in the feed composition is 1:1, the weight of A:B in the eluted composition will be 0.8:1 to 1.2:1, respectively. Similarly, if the weight ratio of protein B to protein C in the feed composition is 2:1, the weight of B:C in the eluted composition will be 1.6:1 to 2.4:1, respectively. Typically, soy protein-containing feed compositions contain glycinin, β-conglycinin, lipoxygenase, r-conglycinin, and β-amylase, each of which have a molecular weight in excess of 50,000 daltons. After a feed composition containing these proteins is passed through a bed of a size exclusion resin having a size exclusion limit less than 50,000 daltons in accordance with this process, therefore, the weight ratio of, for example, glycinin to β-conglycinin, glycinin to lipoxygenase, and β-conglycinin to lipoxygenase will not vary by more than 20%, preferably by no more than 10%, and still more preferably by no more than 5% relative to the feed composition.

During operation of the process, the temperature within the column is not narrowly critical. One consideration is the resin's ability to withstand the process temperature and generally the temperature within the column is no more than 100° C. (212° F.). Typically, the temperature within the column is from 15 to 100° C. (from 60 to 212° F.), more typically from 20 to 80° C. (from 70 to 175° F.), more typically from 20 to 60° C. (from 70 to 140° F.) and, still more typically, from 20 to 40° C. (from 70 to 105° F.). It has been observed that higher temperatures in the column may increase the elution rate which is believed to be due, at least in part, to an increase in viscosity of the soy protein-containing composition.

The pressure within the column is not narrowly critical and is typically maintained below the level at which the resin may become compacted. Typically, the pressure within the column is less than 145 psi (10 bar) and, more typically, less than 70 psi (5 bar).

The viscosity of a soy protein-containing composition treated by the process of the present invention is not narrowly critical and generally any composition having a viscosity enabling them to flow through the column can be treated. The term viscosity as used herein refers to the apparent viscosity of a slurry or a solution as measured with a rotating spindle viscometer utilizing a large annulus, where a particularly preferred rotating spindle viscometer is a Brookfield viscometer. The apparent viscosity of a soy protein material may be measured, for example, by weighing a sample of the soy material and water to obtain a known ratio of the soy material to water (preferably I part soy material to 7 parts water, by weight), combining and mixing the soy material and water in a blender or mixer to form a homogenous slurry of the soy material and water at a temperature of about 20° C. and pH 7, and measuring the apparent viscosity of the slurry with the rotating spindle viscometer utilizing a large annulus, operated at approximately 30 to 60 revolutions per minute (rpm) and at a torque of from 30 to 70%.

The pH of the soy protein-containing composition affects the solubility of the proteins contained therein. Thus, the soy protein-containing composition is generally maintained at a pH which ensures the solubility of the proteins in the soy protein-containing composition. If the proteins do not remain soluble in the soy protein-containing composition to be treated the purity (i.e., protein content) of the treated soy protein-containing composition of soy proteins eluted from the column may be adversely affected. Generally, the soy proteins remain soluble in the soy protein-containing composition when its pH is maintained at from 6 to 10. Typically the pH of the soy protein-containing composition is maintained at from 7 to 10, more typically from 8 to 10 and, still more typically, from 9 to 10.

The overall productivity of this size exclusion process depends on numerous factors including, for example, the efficiency of the column, the residence time of the composition within the bed of size exclusion resin, the characteristics of the soy protein-containing composition (e.g., protein content and solids content), amount of soy protein-containing composition introduced to the column, and its rate of introduction. Generally the process is carried out in such a manner that the amount of soy protein-containing composition introduced to the column and its rate of introduction allow for producing a sufficient amount of treated soy protein-containing composition.

The size exclusion resin may be cleaned and regenerated to allow the resin to be used to treat multiple feed compositions, thus providing an important economic benefit to the overall process. Generally, the resin is contacted with multiple column volumes of one or more chemicals (e.g., sodium hydroxide and ethanol) followed by one or more water washings. One such method includes contacting the resin with 5 column volumes of sodium hydroxide, followed by contacting the resin with 5 column volumes of water, and contacting the resin with 5 column volumes of a 50 wt. % solution of ethanol followed by further water washing by contacting the resin with 5 column volumes of water.

### EXAMPLES

The present invention is illustrated by the following examples which are merely for the purpose of illustration and not to be regarded as limiting the scope of the invention or manner in which it may be practiced.

### Example 1

An aqueous suspension is prepared by adding commercially available defatted soy flour (50 g) to water (950 ml); the aqueous suspension contains approximately 5% by weight solids. The suspension is introduced into a feed reservoir with a capacity of 3 liters. The pH of the aqueous suspension is approximately 6.8. The suspension within the feed reservoir is continuously agitated with a magnetic stirrer, Thermolyne Model # SP 46925, manufactured by Barnsted/Thermolyne (Dubuque, Iowa), to prevent settling of the suspension.

The soy flour in the suspension contains, on a moisture-free basis, approximately 56-59% protein, approximately 5.5-6.4% minerals, approximately 0.5% free fatty acids as determined using the fat ether extraction method, and approximately 32-34% carbohydrates. Prior to being added to water to form an aqueous suspension, the soy flour is heat-treated by subjecting the flour to temperatures of up to 150° C. (305° F.) for from 9 to 15 seconds.

The suspension is continuously removed from the feed reservoir using a peristaltic pump (Masterflex Microprocessor Pump Drive Model # 7524-10 manufactured by Barnant Co. (Barrington, Ill.)) at a rate of between 85 and 90 ml/hr and continuously introduced into a 50 ml Amicon Stirred Ultrafiltration cell modified to produce a resin basket by replacing the ultrafiltration membrane with a macro/micro filtration membrane having a pore size of approximately 300μm, Model # 850, manufactured by Millipore Corporation (Bedford, Mass.). The resin basket contains between 30 and 35 g of a moist, adsorbent resin (Amberlite XAD-16HP) manufactured by Rohm and Haas (Philadelphia, Pa.). The resin has a particle size of from 350 to 850 μm, an average pore size of 100 Å and a density of 1.08 g/ml. Prior to introduction into the resin basket, the resin is washed by contacting with at least 10 bed volumes of water.

The resin basket contains a filter constructed of polyetheretherketone (PEEK) manufactured by Sefar America, Inc. (Depew, N.Y.) in its bottom wall having an average pore size of 297 μm.

Suspension passes continuously through the resin basket and filter at a flow rate of 3 bed volumes/hour for 3 hours. The flow rate within the resin basket ranges from 1.4 to 1.6 ml/min.

Samples of the treated suspension of between 46 and 48 ml are collected from the outlet of the resin basket at 30 minute intervals over three hours of operation. The samples are placed in separate 300 ml beakers for analysis.

The samples are analyzed to determine the whiteness index. The whiteness index measurements are carried out using a HunterLab DP-9000 colorimeter including an optical sensor D-25, both manufactured by Hunter Associates Laboratory (HunterLab) (Reston, Va.).

For comparison purposes, a control soy flour suspension which is not resin treated which contains 5% by weight solids is prepared as described above. The control suspension is agitated continuously for 3 hours; samples of the control suspension are taken at 30 minutes intervals and their whiteness index is measured as described above.

The results of the whiteness index for the treated samples, control samples and a comparison of the results are summarized below in Table 2. As shown in Table 2, the whiteness index of treated samples improves as compared to the untreated, control samples.

TABLE 2

| | |
|---|---|
| Whiteness | Increase in |
| Index of soy | Whiteness |
| flour at pH 6.8 | Index |

| Sample time | | Control | Treated | Net | % |
|---|---|---|---|---|---|
| 0 | | 15.23 | 15.23 | 0 | 0% |
| 30 | min. | 17.32 | 36.54 | 19.22 | 110.9% |
| 60 | min. | 18.47 | 36.47 | 18.0 | 97.5% |
| 90 | min. | 19.22 | 33.59 | 14.37 | 74.8% |
| 120 | min. | 19.85 | 35.66 | 15.81 | 79.6% |
| 150 | min. | 22.19 | 36.43 | 14.24 | 64.2% |
| 180 | min. | 19.96 | 36.74 | 16.78 | 84.1% |

A composite mixture of the 6 treated samples taken at 30 minute intervals is prepared; the whiteness index of the composite mixture was 37.95.

### Example 2

An aqueous suspension is prepared by adding heat-treated soy flour (50 g) to water (950 ml); the aqueous suspension contains approximately 5% by weight solids. The pH of the suspension is maintained at 6.5. The suspension is continuously introduced to the resin basket described in Example 1. In the present example, the resin basket contains between 30 and 35 g of a moist, adsorbent resin (Sepabeads SP-70) manufactured by Mitsubishi Chemicals (now Itochu Specialty Chemicals, Inc.) (Carmel, Ind.) and having an average particle size of 250-350 μm, an average pore size of 65 Å, and density of 1.01 g/ml. Prior to introduction into the resin basket, the resin is passed through a sieve having a pore size of 350 μm, thus the SP-70 resin in the resin basket contains particles having a size greater than 350 μm.

The soy flour in the suspension contains, on a moisture-free basis, approximately 56-59% protein, approximately 5.5-6.4% minerals, approximately 0.5% free fatty acids as determined using the fat ether extraction method, and approximately 32-34% carbohydrates. Prior to being added to water to form an aqueous suspension, the soy flour is heat-treated as described above in Example 1.

As in Example 1, the suspension passes through the resin basket at a flow rate of 3 bed volumes/hour for 3 hours; the flow rate within the resin basket ranges from 1.4 to 1.7 m/min. Samples of between 46 and 48 ml are collected from the outlet of the resin basket as described in Example 1 at 30 min increments and placed in separate 300 ml beakers for analysis. Each sample is analyzed as described above in Example 1 to determine its whiteness index.

A control soy flour suspension which was not resin treated is prepared as described above in the present example. The control suspension is agitated continuously for 3 hours; samples of the control suspension are taken at 30 minutes intervals and their whiteness index measured as described in Example 1.

The results of the whiteness index for the treated samples, control sample and a comparison of the results are summarized below in Table 3. As shown in Table 3, the whiteness index of treated samples improves as compared to the untreated, control samples.

TABLE 3

| | |
|---|---|
| Whiteness | |
| Index of | |
| heat treated | Increase in |
| soy flour | Whiteness |
| at pH 6.5 | Index |

| Sample time | | Control | Treated | Net | % |
|---|---|---|---|---|---|
| 0 | | 40.13 | 40.13 | 0 | %0 |
| 30 | min. | 40.13 | 52.46 | 12.33 | 30.7% |
| 60 | min. | 40.13 | 52.36 | 12.23 | 30.5% |
| 90 | min. | 40.13 | 51.56 | 11.43 | 28.5% |
| 120 | min. | 40.13 | 50.78 | 10.65 | 26.5% |
| 150 | min. | 40.13 | 49.86 | 9.73 | 24.2% |
| 180 | min. | 41.13 | 49.62 | 8.49 | 20.6% |

A composite mixture of the 6 treated samples taken at 30 minute intervals is prepared; the whiteness index of the composite mixture was 51.08.

### Example 3

An aqueous suspension is prepared as described in Example 2 by adding the soy flour described in Example 2 (50 g) to water (950 ml); the aqueous suspension contains approximately 5% by weight solids. The pH of the suspension is maintained at 6.5. The suspension is continuously introduced to the resin basket described above in Example 1. In the present example, the resin basket contains between 30 and 35 g of a moist, adsorbent resin (Dowex Optipore SD-2) manufactured by Dow Chemicals (Midland, Mich.) having a particle size of from 300 to 850 μm and an average pore size of 60 Å. Prior to being added to water to form an aqueous suspension, the soy flour is heat-treated by subjecting the flour to temperatures of up to 150° C. (305° F.) for from 9 to 15 seconds.

As in Example 1, the suspension passes through the resin basket at a flow rate of 3 bed volumes/hour for 3 hours; the flow rate within the resin basket is 1.7 ml/min. Samples of between 46 and 48 ml are collected from the outlet of the resin basket as described in Example 1 at 30 min increments and placed in separate 300 ml beakers for analysis. Each sample is analyzed as described above in Example 1 to determine its whiteness index.

A control soy flour suspension which was not resin treated is prepared as described above in Example 2. The control suspension is agitated continuously for 3 hours; samples of the control suspension are taken at 30 minutes intervals and their whiteness index measured as described in Example 1.

The results of the whiteness index for the treated samples, control samples and a comparison of the results are summarized below in Table 4. As shown in Table 4, the whiteness index of treated samples improves as compared to the untreated, control samples.

TABLE 4

| | |
|---|---|
| Whiteness | |
| Index of | |
| heat treated | Increase in |
| soy flour | Whiteness |
| at pH 6.5 | Index |

| Sample time | | Control | Treated | Net | % |
|---|---|---|---|---|---|
| 0 | | 37.46 | 37.46 | 0 | 0% |
| 30 | min. | 38.95 | 56.65 | 17.7 | 45.4% |
| 60 | min. | 39.92 | 52.23 | 12.31 | 30.8% |
| 90 | min. | 40.19 | 51.65 | 11.46 | 28.5% |
| 120 | min. | 41.13 | 50.42 | 9.29 | 22.6% |
| 150 | min. | 41.13 | 50.44 | 9.31 | 22.6% |
| 180 | min. | 41.29 | 49.91 | 8.62 | 20.9% |

A composite mixture of the 6 treated samples taken at 30 minute intervals is prepared; the whiteness index of the composite mixture is 51.76.

### Example 4

An aqueous suspension is prepared by adding soy protein isolate (50 g) to water (950 ml); the aqueous suspension contains approximately 5% by weight solids. The pH of the suspension is maintained at 6.8. The suspension is continuously introduced to the resin basket described in Example 1. The resin basket contains between 30 and 35 g of the moist, adsorbent resin (Amberlite XAD-16HP) manufactured by Rohm and Haas (Philadelphia, Pa.) described in Example 1.

The soy protein isolate is prepared from spray dried acid curd and contains, on a moisture-free basis, approximately 91% protein, approximately 4% minerals, approximately 0.6% free fatty acids as determined using the fat ether extraction method, and approximately 3-4% carbohydrates. Prior to being added to water to form an aqueous suspension, the soy protein isolate is heat-treated as described above in Example 1.

Suspension passes through the resin basket at a flow rate of 3 bed volumes/hour for 3 hours; the flow rate within the resin basket is 1.6 ml/min. Samples of between 46 and 48 ml are collected from the outlet of the resin basket as described in Example 1 at 30 min increments and placed in separate 300 ml beakers for analysis. Each sample is analyzed as described above in Example 1 to determine its whiteness index.

A control soy protein isolate suspension which was not resin treated is prepared as described above in the present example. The control suspension is agitated continuously for 3 hours; samples of the control suspension are taken at 30 minutes intervals and their whiteness index measured as described in Example 1.

The results of the whiteness index for the treated samples, control samples and a comparison of the results are summarized below in Table 5. As shown in Table 5, the whiteness index of treated samples improves as compared to the untreated, control samples.

TABLE 5

| | |
|---|---|
| Whiteness | |
| Index of soy | Increase in |
| protein isolate | Whiteness |
| at pH 6.8 | Index |

| Sample time | | Control | Treated | Net | % |
|---|---|---|---|---|---|
| 0 | | 35.35 | 35.35 | 0 | 0% |
| 30 | min. | 34.97 | 41.04 | 6.07 | 17.4% |
| 60 | min. | 34.57 | 41.68 | 7.11 | 20.6% |
| 90 | min. | 35.44 | 41.29 | 5.58 | 16.5% |
| 120 | min. | 35.13 | 41.34 | 6.21 | 17.7% |
| 150 | min. | 35.27 | 41.00 | 5.73 | 16.2% |
| 180 | min. | 35.79 | 40.54 | 4.75 | 13.3% |

A composite mixture of the 6 treated samples taken at 30 minute intervals is prepared; the whiteness index of the composite mixture was 40.72.

### Example 5

An aqueous suspension is prepared by adding soy protein isolate (50 g) described in Example 4 to water (950 ml); the suspension contains approximately 5% by weight solids. The pH of the suspension is maintained at 6.8. The suspension is continuously introduced to the resin basket described in Example 1. The resin basket contains between 30 and 35 g of the moist, adsorbent resin (Optipore SD-2) described in Example 3.

Suspension passes through the resin basket at a flow rate of 3 bed volumes/hour for 3 hours; the flow rate within the resin basket is 1.4 to 1.6 ml/min. Samples of between 46 and 48 ml are collected from the outlet of the resin basket as described in Example 1 at 30 min increments and placed in separate 300 ml beakers for analysis. Each sample is analyzed as described above in Example 1 to determine its whiteness index.

A control soy protein isolate suspension which is not resin treated is prepared as described above in Example 4. The control suspension is agitated continuously for 3 hours; samples of the control suspension are taken at 30 minutes intervals and their whiteness index measured as described in Example 1.

The results of the whiteness index for the treated samples, control samples and a comparison of the results are summarized below in Table 6. As shown in Table 6, the whiteness index of treated samples improves as compared to the untreated, control samples.

TABLE 6

| | |
|---|---|
| Whiteness | |
| Index of soy | Increase in |
| protein isolate | Whiteness |
| at pH 6.8 | Index |

| Sample time | | Control | Treated | Net | % |
|---|---|---|---|---|---|
| 0 | | 37.69 | 37.69 | 0 | 0% |
| 30 | min. | 40.75 | 54.35 | 13.6 | 33.3% |
| 60 | min. | 37.84 | 44.82 | 6.98 | 18.4% |
| 90 | min. | 37.11 | 45.39 | 8.28 | 22.3% |
| 120 | min. | 37.11 | 43.78 | 6.67 | 17.9% |
| 150 | min. | 37.11 | 43.73 | 6.62 | 17.8% |
| 180 | min. | 38.58 | 45.27 | 6.69 | 17.3% |

A composite mixture of the 6 treated samples taken at 30 minute intervals is prepared; the whiteness index of the composite mixture is 46.99.

### Example 6

An aqueous suspension is prepared by adding soy protein isolate (50 g) described in Example 4 to water (950 ml); the suspension contains 5% by weight solids. The pH of the suspension is maintained at 8. The suspension is continuously introduced to the resin basket described in Example 1. The resin basket contains between 30 and 35 g of the moist, adsorbent resin (Optipore SD-2) described in Example 3.

A control soy protein isolate suspension which is not resin treated is prepared as described above in Example 4. The control suspension is agitated continuously for 3 hours; samples of the control are taken at 30 minute intervals and their whiteness index measured as described in Example 1.

The results of the whiteness index for the treated samples, control samples and a comparison of the results are summarized below in Table 7. As shown in Table 7, the whiteness index of treated samples improves as compared to the untreated, control samples.

TABLE 7

| | |
|---|---|
| Whiteness | |
| Index of soy | Increase in |
| protein isolate | Whiteness |
| at pH 8 | Index |

| Sample time | | Control | Treated | Net | % |
|---|---|---|---|---|---|
| 0 | | 21.9 | 21.9 | 0 | 0% |
| 30 | min. | 22.43 | 37.01 | 14.58 | 65.0% |
| 60 | min. | 22.06 | 34.97 | 12.91 | 58.5% |
| 90 | min. | 22.06 | 34.8 | 12.74 | 57.8% |
| 120 | min. | 22.06 | 34.88 | 12.82 | 58.1% |
| 150 | min. | 22.06 | 33.19 | 11.13 | 50.5% |
| 180 | min. | 24.29 | 33.85 | 9.56 | 39.4% |

### Example 7

An aqueous suspension is prepared by adding soy protein concentrate (50 g) to water (950 ml); the suspension contains 5% by weight solids. The pH of the suspension is maintained at 6.8. The suspension is continuously introduced to the resin basket described in Example 1. The resin basket contains between 30 and 35 g of the moist, adsorbent resin (Optipore SD-2) described in Example 3.

The soy protein concentrate in the suspension contains, on a moisture-free basis, approximately 75-81% protein, approximately 3.3-3.7% calcium, approximately 1% sodium, approximately 0.5% free fatty acids as determined using the fat ether extraction method, and approximately 15-20% carbohydrates. Prior to being added to water to form an aqueous suspension, the soy protein concentrate is heat-treated as described above in Example 1.

Suspension passes through the resin basket at a flow rate of 3 bed volumes/hour for 3 hours; the flow rate within the resin basket is 1.6 ml/min. Samples of between 46 and 48 ml are collected from the outlet of the resin basket as described in Example 1 at 30 min increments and placed in separate 300 ml beakers for analysis. Each sample is analyzed as described above in Example 1 to determine its whiteness index.

A control soy protein concentrate suspension which is not resin treated is prepared as described above in the present example. The control suspension is agitated continuously for 3 hours; samples of the control are taken at 30 minute intervals and their whiteness index measured as described in Example 1.

The results of the whiteness index for the treated samples, control samples and a comparison of the results are summarized below in Table 8. As shown in Table 8, the whiteness index of treated samples improves as compared to the untreated, control samples.

TABLE 8

| | |
|---|---|
| Whiteness | |
| Index of soy | |
| protein | Increase in |
| concentrate at | Whiteness |
| pH 6.8 | Index |

| Sample time | | Control | Treated | Net | % |
|---|---|---|---|---|---|
| 0 | | 43.43 | 43.43 | 0 | 0% |
| 30 | min. | 43.86 | 53.10 | 9.24 | 21.1% |
| 60 | min. | 44.36 | 52.18 | 7.82 | 17.6% |
| 90 | min. | 44.39 | 52.56 | 8.17 | 18.4% |
| 120 | min. | 44.61 | 52.70 | 8.09 | 18.1% |
| 150 | min. | 45.23 | 52.94 | 7.71 | 17.0% |
| 180 | min. | 45.23 | 53.25 | 8.02 | 17.7% |

A composite mixture of the 6 treated samples taken at 30 minute intervals is prepared; the whiteness index of the composite mixture is 53.29.

### Example 8

An aqueous suspension is prepared by adding soy protein concentrate (50 g) described in Example 7 to water (950 ml); the suspension contains approximately 5% by weight solids. The pH of the suspension is maintained at 7.2. The continuously introduced to the resin basket described in Example 1. The resin basket contains between 30 and 35 g of a moist, ion exchange resin (Diaion PA308) manufactured by Mitsubishi Chemicals (now Itochu Specialty Chemicals, Inc.) (Carmel, Ind.) having a particle size of from 300 to 900 μm. Prior to being added to water to form an aqueous suspension, the soy protein concentrate is heat-treated as described above in Example 1.

Suspension passes through the resin basket at a flow rate of 3 bed volumes/hour for 3 hours; the flow rate within the resin basket is 1.6 ml/min. Samples of between 46 and 48 ml are collected from the outlet of the resin basket as described in Example 1 at 30 min increments and placed in separate 300 ml beakers for analysis. Each sample is analyzed as described above in Example 1 to determine its whiteness index.

A control soy protein concentrate suspension which is not resin treated is prepared as described above in Example 7. The control suspension is agitated continuously for 3 hours; samples of the control are taken at 30 minute intervals and their whiteness index measured as described in Example 1.

The results of the whiteness index for the treated samples, control samples and a comparison of the results are summarized below in Table 9. As shown in Table 9, the whiteness index of treated samples improves as compared to the untreated, control samples.

TABLE 9

| | |
|---|---|
| Whiteness | |
| Index of soy | |
| protein | Increase in |
| concentrate at | Whiteness |
| pH 7.2 | Index |

| Sample time | | Control | Treated | Net | % |
|---|---|---|---|---|---|
| 0 | | 42.76 | 42.73 | −0.03 | −0.07 |
| 30 | min. | 43.92 | 52.07 | 8.15 | 18.6% |
| 60 | min. | 44.19 | 52.59 | 8.40 | 19% |
| 90 | min. | 47.24 | 52.77 | 5.53 | 11.7% |
| 120 | min. | 45.37 | 52.96 | 7.59 | 16.7% |
| 150 | min. | 45.35 | 52.98 | 7.63 | 16.8% |
| 180 | min. | 45.19 | 51.93 | 6.74 | 14.9% |

A composite mixture of the 6 treated samples taken at 30 minute intervals is prepared; the whiteness index of the composite mixture is 52.98.

### Example 9

An aqueous suspension is prepared by adding soy protein concentrate (50 g) described in Example 7 to water (950 ml); the suspension contains approximately 5% by weight solids. The pH of the suspension is maintained at 7. The suspension is continuously introduced to the resin basket described in Example 1. The resin basket contains between 30 and 35 g of a moist, ion exchange resin, Diaion SA 11A, manufactured by Mitsubishi Chemicals (now Itochu Specialty Chemicals, Inc.) (Carmel, Ind.) having a particle size of from 300 to 900 μm. Prior to being added to water to form an aqueous suspension, the soy protein concentrate is heat-treated as described above in Example 1.

Suspension passes through the resin basket at a flow rate of 3 bed volumes/hour for 3 hours; the flow rate within the resin basket is from 1.5 to 1.7 ml/min. Samples of between 46 and 48 ml are collected from the outlet of the resin basket as described in Example 1 at 30 min increments and placed in separate 300 ml beakers for analysis. Each sample is analyzed as described above in Example 1 to determine its whiteness index.

A control soy protein concentrate suspension which is not resin treated is prepared as described above in Example 7. The control suspension is agitated continuously for 3 hours; samples of the control are taken at 30 minute intervals and their whiteness index measured as described in Example 1.

The results of the whiteness index for the treated samples, control samples and a comparison of the results are summarized below in Table 10. As shown in Table 10, the whiteness index of treated samples improves as compared to the untreated, control samples.

TABLE 10

| | |
|---|---|
| Whiteness | |
| Index of soy | Increase |
| protein | in |
| concentrate | Whiteness |
| at pH 7.0 | Index |

| Sample time | | Control | Treated | Net | % |
|---|---|---|---|---|---|
| 0 | | 43.75 | 43.75 | 0 | 0% |
| 30 | min. | 43.65 | 50.45 | 6.8 | 15.6% |
| 60 | min. | 44.25 | 51.13 | 6.88 | 15.5% |
| 90 | min. | 44.80 | 51.53 | 6.73 | 15.0% |
| 120 | min. | 45.02 | 51.61 | 6.59 | 14.6% |
| 150 | min. | 45.25 | 51.72 | 6.47 | 14.3% |
| 180 | min. | 45.72 | 51.91 | 6.19 | 13.5% |

A composite mixture of the 6 treated samples taken at 30 minute intervals is prepared; the whiteness index of the composite mixture is 52.35.

### Example 10

An aqueous suspension is prepared by adding soy protein concentrate (50 g) described in Example 7 to water (950 ml); the suspension contains approximately 5% by weight solids. The pH of the suspension is maintained at 7.2. The suspension is continuously introduced to the resin basket described in Example 1. The resin basket contains between 30 and 35 g of the moist, adsorbent resin (Sepabeads SP-70) described in Example 2. Prior to being added to water to form an aqueous suspension, the soy protein concentrate is heat-treated as described above in Example 1.

Suspension passes through the resin basket at a flow rate of 3 bed volumes/hour for 3 hours; the flow rate within the resin basket is from 1.5 to 1.7 ml/min. Samples of between 46 and 48 ml are collected from the outlet of the resin basket as described in Example 1 at 30 min increments and placed in separate 300 ml beakers for analysis. Each sample is analyzed as described above in Example 1 to determine its whiteness index.

A control soy protein concentrate suspension which is not resin treated is prepared as described above in Example 7. The control suspension is agitated continuously for 3 hours; samples of the control are taken at 30 minute intervals and their whiteness index measured as described in Example 1.

The results of the whiteness index for the treated samples, control samples and a comparison of the results are summarized below in Table 11. As shown in Table 11, the whiteness index of treated samples improves as compared to the untreated, control samples.

TABLE 11

| | |
|---|---|
| Whiteness | |
| Index of soy | |
| protein concentrate | Increase in |
| at pH 7.2 | Whiteness Index |

| Sample time | | Control | Treated | Net | % |
|---|---|---|---|---|---|
| 0 | | 43.75 | 43.75 | 0 | 0% |
| 30 | min. | 43.34 | 52.87 | 9.53 | 21.9% |
| 60 | min. | 43.88 | 51.58 | 7.7 | 17.5% |
| 90 | min. | 44.32 | 51.45 | 7.13 | 16.1% |
| 120 | min. | 44.36 | 51.47 | 7.11 | 16.0% |
| 150 | min. | 44.78 | 49.40 | 4.62 | 10.3% |
| 180 | min. | 45.11 | 51.27 | 6.16 | 13.7% |

A composite mixture of the 6 treated samples taken at 30 minute intervals is prepared; the whiteness index of the composite mixture is 52.12.

### Example 11

An aqueous suspension is prepared by adding soy protein concentrate (50 g) described in Example 7 to water (950 ml). The suspension contains approximately 5% by weight solids. The pH of the suspension is maintained at 7.3. The suspension is continuously introduced to the resin basket described in Example 1. The resin basket contains between 30 and 35 g of the moist, adsorbent resin (Amberlite XAD-16HP) described in Example 1. Prior to being added to water to form an aqueous suspension, the soy protein concentrate is heat-treated as described above in Example 1.

Suspension passes through the resin basket at a flow rate of 3 bed volumes/hour for 3 hours; the flow rate within the resin basket is 1.6 ml/min. Samples of between 46 and 48 ml are collected from the outlet of the resin basket as described in Example 1 at 30 min increments and placed in separate 300 ml beakers for analysis. Each sample is analyzed as described above in Example 1 to determine its whiteness index.

A control soy protein concentrate suspension which is not resin treated is prepared as described above in Example 7. The control suspension is agitated continuously for 3 hours; samples of the control are taken at 30 minute intervals and their whiteness index measured as described in Example 1.

The results of the whiteness index for the treated samples, control samples and a comparison of the results are summarized below in Table 12. As shown in Table 12, the whiteness index of treated samples improves as compared to the untreated, control samples.

TABLE 12

| | |
|---|---|
| Whiteness Index | |
| of soy protein | Increase in |
| concentrate at | Whiteness |
| pH 7.3 | Index |

| Sample time | | Control | Treated | Net | % |
|---|---|---|---|---|---|
| 0 | | 42.27 | 42.27 | 0 | 0% |
| 30 | min. | 43.09 | 51.80 | 8.71 | 20.2% |
| 60 | min. | 44.06 | 50.87 | 6.81 | 15.5% |
| 90 | min. | 44.41 | 51.11 | 6.7 | 15.1% |
| 120 | min. | 44.49 | 51.16 | 6.67 | 14.9% |
| 150 | min. | 44.73 | 51.08 | 6.35 | 14.2% |
| 180 | min. | 45.37 | 51.28 | 5.91 | 13.0% |

A composite mixture of the 6 treated samples taken at 30 minute intervals is prepared; the whiteness index of the composite mixture is 51.55.

### Example 12

A 5% by weight aqueous suspension is prepared by adding soy protein concentrate (50 g) to water (950 ml); the suspension contains approximately 5% by weight solids. The pH of the suspension is maintained at 7.2. The suspension is continuously introduced to the resin basket described in Example 1. The resin basket contains between 30 and 35 g of the moist, adsorbent resin (Sepabeads SP-70) described in Example 2.

The mineral enriched soy protein concentrate in the suspension contains, on a moisture-free basis, approximately 81-85% protein, approximately 11% minerals, approximately 2.8-3.5% calcium, approximately 0.7% sodium, approximately 0.5% free fatty acids as determined using the fat ether extraction method, and approximately 4-8% carbohydrates. Prior to being added to water to form an aqueous suspension, the soy protein concentrate is heat-treated as described above in Example 1.

Suspension passes through the resin basket at a flow rate of 3 bed volumes/hour for 3 hours; the flow rate within the resin basket is 1.6 ml/min. Samples of between 46 and 48 ml are collected from the outlet of the resin basket as described in Example 1 at 30 min increments and placed in separate 300 ml beakers for analysis. Each sample is analyzed as described above in Example 1 to determine its whiteness index.

A control soy protein concentrate suspension which is not resin treated is prepared as described above in the present example. The control suspension is agitated continuously for 3 hours; samples of the control are taken at 30 minute intervals and their whiteness index measured as described in Example 1.

The results of the whiteness index for the treated samples and control samples compared to the 0 minute value of the control sample are summarized below in Table 13. As shown in Table 13, the whiteness index of treated samples improves as compared to the untreated, control samples.

TABLE 13

| | |
|---|---|
| Whiteness | |
| Index of | |
| soy protein | Increase in |
| concentrate at | Whiteness |
| pH 7.2 | Index |

| Sample time | | Treated | Net | % |
|---|---|---|---|---|
| 0 | | 50.11 | 0 | 0% |
| 30 | min. | 58.02 | 7.91 | 15.8% |
| 60 | min. | 56.56 | 6.45 | 12.9% |
| 90 | min. | 56.07 | 5.96 | 11.9% |
| 120 | min. | 55.01 | 4.9 | 9.8% |
| 150 | min. | 55.10 | 4.99 | 9.9% |
| 180 | min. | 55.15 | 5.04 | 10% |

A composite mixture of the 6 treated samples taken at 30 minute intervals is prepared; the whiteness index of the composite mixture is 56.03.

### Example 13

A 5% by weight solids aqueous suspension is prepared by adding soy protein concentrate described in Example 12 (200 g) to water (3800 ml). The pH of the soy protein concentrate suspension is 6.8. The suspension is continuously introduced to a 400 ml resin basket prepared by modifying an ultrafiltration cell as described in Example 1 which contains between 200 and 250 g of the moist, adsorbent resin (Sepabeads SP-70), described in Example 2. Prior to being added to water to form an aqueous suspension, the soy protein concentrate is heat-treated as described above in Example 1.

4000 ml of the suspension passes through the resin basket at a flow rate of 5 bed volumes/hour for 4 hours; over the course of the 4 hours of operation, the flow rate of the suspension through the resin basket is 17 ml/min. The treated suspension is then spray dried.

A control soy protein concentrate suspension which is not resin treated is prepared as described above in the present example.

Viscosities of the control suspension and the resin treated suspensions are determined using a Brookfield Programmable DV-II+ Viscometer, LVDV-II+ manufactured by Brookfield Engineering Laboratories, Inc. (Middleboro, Mass.), at 20 □ C using a No. 2 spindle. The viscosity of the control suspension (10% solids in water) is approximately 93.2 centipoise. The viscosity of the resin treated suspension (10% solids in water) is approximately 67 centipoise.

The whiteness indices of the control and resin treated samples are summarized below in Table 14.

TABLE 14

| Whiteness | | | | |
|---|---|---|---|---|
| Index | Overall | L | a | b |
| Control | 46 | 76.3 | −1.9 | 10.1 |
| Resin Treated | 51.2 | 76.7 | −1.8 | 8.5 |

Further characteristics of the control and treated samples (e.g., moisture content, protein content, and fat content) are summarized below in Table 15.

TABLE 15

| Feature | Control | Resin Treated |
|---|---|---|
| Moisture (%) | 4.49 | 5.28 |
| Protein content (wet basis; | 82.0 | 82.3 |
| determined using the | | |
| Kjeldahl method) (%) | | |
| Protein content (dry basis; | 85.9 | 86.9 |
| determined using the | | |
| Kjeldahl method) (%) | | |
| Fat content (%) | 4.52 | 4.18 |
| (determined using the acid | | |
| hydrolysis method) | | |
| Calcium content (%) | 3.05 | 3.13 |
| Ash content (%) | 11.1 | 11.4 |
| Total Isoflavone content | 1640 | 204 |
| (ppm) | | |

As shown in Table 15, resin treatment of the sample provides a reduction in total isoflavone content of approximately 88%.

The isoflavone profile of the control sample and resin treated samples are described in detail in Table 16. The isoflavone contents are determined by High Performance Liquid Chromatography (HPLC) using a Beckman Instruments Chromatograph equipped with a UV detector and a Hypersil column having a 2.1 mm diameter and 200 mm height manufactured by Hewlett-Packard (Palo Alto, Calif.).

TABLE 16
Isoflavone Profile of Control and Resin Treated Soy Protein Concentrate

| | | Resin Treated |
|---|---|---|
| Isoflavone Profile | Control (ppm) | Sample (ppm) |
| Daidzin | 99 | 11 |
| 6-OMal-Daidzin | 320 | 33 |
| 6-OAc-Daidzin | 35 | 3 |
| Daidzein | 23 | 8 |
| Total Daidzein Compounds | 477 | 55 |
| Genistin | 251 | 23 |
| 6-OMal-Genistin | 644 | 68 |
| 6-OAc-Genistin | 95 | 13 |
| Genistein | 32 | 12 |
| Total Genistein Compounds | 1020 | 116 |
| Glycitin | 57 | 24 |
| 6-OMal-Glycitin | 88 | 9 |
| Glycitein | <1 | <1 |
| Total Glycitein Compounds | 145 | 33 |
| Total Isoflavones | 1640 | 204 |
| Daidzin (aglucone units) | 60 | 7 |
| 6-OMal-Daidzin (aglucone units) | 162 | 17 |
| 6-OAc-Daidzin (aglucone units) | 19 | 2 |
| Daidzein (aglucone units) | 23 | 8 |
| Total Daidzein (aglucone units) | 264 | 34 |
| Genistin (aglucone units) | 157 | 14 |
| 6-OMal-Genistin (aglucone units) | 336 | 35 |
| 6-OAc-Genistin (aglucone units) | 54 | 7 |
| Genistein (aglucone units) | 32 | 12 |
| Total Genistein (aglucone units) | 579 | 68 |
| Glycitin (aglucone units) | 36 | 15 |
| 6-OMal-Glycitin (aglucone units) | 47 | 5 |
| Glycitein (aglucone units) | <1 | <1 |
| Total Glycitein (aglucone units) | 83 | 20 |
| Total All Forms (aglucone units) | 926 | 122 |

As shown in Table 16, resin treatment provides a reduction in daidzein compounds of 422 ppm (approximately 88%); a reduction in genistein compounds of 904 ppm (approximately 89%); and a reduction in glycitein compounds of 112 ppm (approximately 77%).

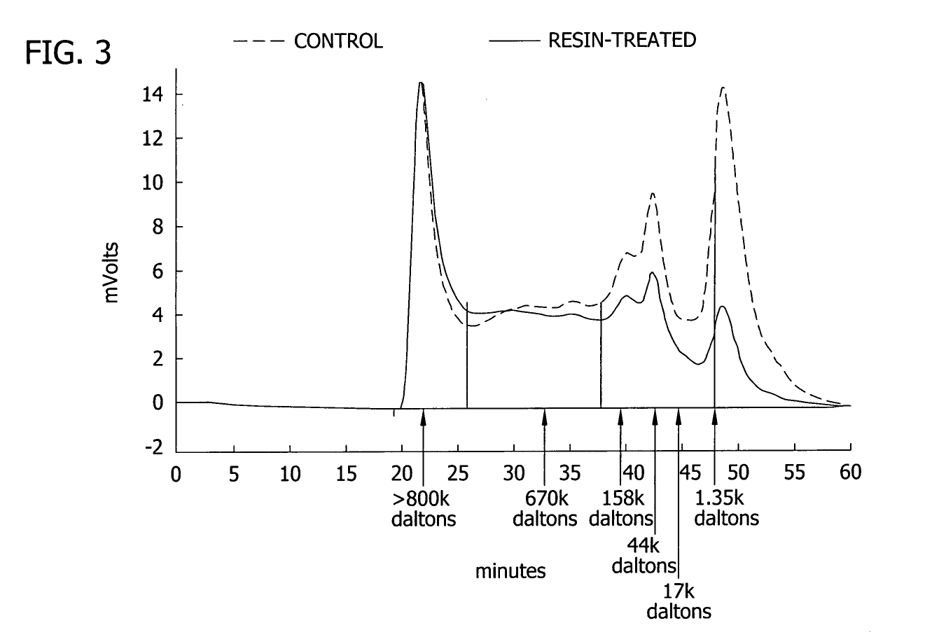

FIG. 3 is an HPLC pattern for a sample resin treated in accordance with the present example. As shown in FIG. 3, resin treatment partially removes lower molecular weight materials or materials having ultraviolet absorbance at low molecular weight levels. The HPLC pattern shown in FIG. 3 is determined using a 300×7.8 mm chromatography column containing a size exclusion resin, BioSel Sec 400, manufactured by BioRad (Hercules, Calif.). It is presently believed that at least a portion of the lower molecular weight materials removed include hydrophobic peptides which may affect the suspendability of the resin treated sample.

Table 17 shows the amounts of flavor and odor causing components in the dried control and resin treated samples. The compositions are determined using an SPME Gas Chromatograph/Mass Spectrometer. The GC/MS chromatograph is manufactured by Agilent (Wilmington, Del.); the SPME is manufactured by Supelco (Bellefonte, Pa.). The concentrations are based on peak area comparison with that of the internal standard, 4-heptanone.

TABLE 17
GC/MS Analysis of Control and Resin Treated Soy Protein Concentrate

Concentration (ppb)

| Component | Control | Resin Treated |
|---|---|---|
| 3-Methyl butanal | 0.9 | 0.6 |
| 2-Methyl butanal | 0.5 | 0.3 |
| Pentanal | 24.3 | 7.9 |
| Dimethyl disulfide | 2.0 | 0.2 |
| Hexanal | 132.6 | 82.8 |
| Heptanal | 2.6 | 1.7 |
| 2,3-Octanedione | 1.2 | 0.9 |
| 1-Octen-3-ol | 0.9 | 0.6 |
| 2-Octanone | 2.3 | 0.4 |
| 2-Pentyl furan | 5.0 | 1.3 |
| 3-Octen-2-one | 3.1 | 0.8 |
| 3,5-Octadien-2-one | 1.6 | 0.3 |
| 3,5-Octadien-2-one | 1.4 | 0.2 |
| 2-Nonanone | 0.3 | ND |
| Nonanal | 0.7 | 1.0 |
| Total | 179.4 | 99 |

As shown in Table 17, resin treatment reduces the amount of volatile components.

The spray dried, resin treated sample is tested for its flavor by a trained panel of 6 testers. The spray dried, resin treated samples prepared in accordance with the present example are compared to a 5% by weight slurry of the spray dried control sample described above. The control sample is assigned a value of 4.0 and the resin treated sample given a rating relative to the control sample, the scale used by the testers is described below in Table 18. The results of the test are summarized below in Table 19.

TABLE 18

| Assigned value | Flavor |
|---|---|
| 5 | Stronger soy off flavor as |
| | compared to control |
| 4 | Same soy off flavor as |
| | compared to control |
| 3 | Slightly reduced soy off flavor |
| | as compared to control |
| 2 | Reduced soy off flavor as |
| | compared to control |
| 1 | Barely detectable soy off |
| | flavor |

TABLE 19

| Sample | Soy Flavor | Bitterness | Astringency | Comments |
|---|---|---|---|---|
| 5% Slurry of | 2.3 | 3.3 | 3.5 | Consensus |
| spray dried, | | | | among testers |
| resin treated | | | | that the resin |
| sample | | | | treated sample |
| | | | | had a much |
| | | | | cleaner flavor |
| | | | | than the control |
| | | | | sample. |
| 5% slurry of | 4.0 | 4.0 | 4.0 | Typical soy |
| spray dried | | | | flavor |
| control sample | | | | |

### Example 14

A soy protein extract is prepared by extraction of soy flour at pH 7. The soy protein extract contains, on a moisture-free basis, approximately 65-67% protein, approximately 8% minerals, approximately 0.6% free fatty acids, as determined using the fat ether extraction method, and approximately 25% carbohydrates. The suspension is then clarified by centrifugation and removal of insolubles such as soy fiber.

340 kg (750 lbs) of an approximately 5% by weight solids clarified suspension of the extract is continuously introduced to a 60 gallon resin basket having a stainless steel sieve having a pore size of from 250 to 300 μm as its bottom wall. The resin basket contains 25 liters of the moist, adsorbent resin (Sepabeads SP-70), described in Example 2. The pH of the suspension is maintained at 6.8. The 340 kg (750 lbs) of the suspension passes through the resin basket at a flow rate of 2.5 kg/min (5.5 lbs/min) for 135 minutes. A total of four samples of the suspension, at the outset and at 45 minute intervals during flow through the resin basket, are taken for analysis.

A soy protein curd is precipitated from a mixture of the 4 samples using hydrochloric acid at a pH of approximately 4.5. The resulting soy protein curd is diluted to approximately 12% by weight solids and its pH is adjusted to approximately 7.2. The diluted curd is then heat treated at approximately 150° C. (305° F.) under pressure (up to 5000 psig) in the presence of steam, flash cooled by decreasing the pressure which releases the steam and cools the curd to approximately 50° C. (125° F.), and spray dried.

A control 5% by weight solids suspension of the soy protein extract which is not resin treated is prepared and clarified by centrifugation. A soy protein curd is precipitated from the clarified suspension using hydrochloric acid at a pH of approximately 4.5. The curd is diluted to approximately 12% by weight solids and its pH is adjusted to approximately 7.2. The curd suspension is then heat treated, flash cooled, and spray dried as described above.

The control and resin treated samples are analyzed to determine viscosities, emulsion strength, compression hardness, chewiness, whiteness index, volatile component content, and nonvolatile component content.

Viscosities of 10% by weight solids resin treated and control suspensions are determined as described above in Example 13. The viscosity of the control suspension is approximately 105 centipoise while the viscosity of the resin treated sample is approximately 165 centipoise.

Emulsion strength of the resin treated and control samples are determined using a TA.TXT2 Texture Analyzer manufactured by Stable Micro Systems Ltd. (England), Texture Technologies Corp. (Scarsdale, N.Y.). The emulsion strength of the control sample is approximately 1220 grams while the emulsion strength of the resin treated sample is approximately 1433 grams. Thus, the resin treated sample exhibited an increase in emulsion strength of approximately 19%.

Two samples of the European emulsified meat formula are prepared. One sample contains 13% by weight pork trimmings and 4% by weight of the control soy protein extract described in the present example. The other sample contains 13% by weight pork trimmings and 4% by weight of the resin treated soy protein extract described in the present example. The compression hardness and the chewiness of each of samples are determined using the texture analyzer described above. The meat formula containing the control sample exhibited a compression hardness of 5156 grams and a chewiness of 902 grams. The meat formula containing the treated sample exhibited a compression hardness of 5589 grams and a chewiness of 1030 grams. Thus, the meat formula containing the resin treated sample exhibited an increase in compression hardness of 8.4% and an increase in chewiness of 14% as compared to the meat formula containing the control sample.

The whiteness index of the resin treated suspension throughout the 135 minutes of operation is summarized below in Table 20.

TABLE 20

| Time (min) | L | a | b | WI |
|---|---|---|---|---|
| 0 | 61.21 | −4.31 | 11.98 | 25.27 |
| 45 | 59.82 | −4.19 | 8.81 | 33.39 |
| 90 | 60.37 | −3.66 | 8.82 | 33.91 |
| 135 | 62.28 | −3.63 | 8.82 | 35.82 |

The volatile component content of the resin treated suspension over the course of the 135 minutes of operation is summarized below in Table 21.

TABLE 21

| | Amount (ppm) | | | |
|---|---|---|---|---|
| Volatile Component | 0 | 45 min | 90 min | 135 min |
| Dimethyl Sulfide | 0.7 | 0 | 0 | 0 |
| Pentanal | 50.3 | 21.3 | 24.0 | 24.0 |
| Hexanal | 657.9 | 226.6 | 231.6 | 228.9 |
| 1-Octen-3-Ol | 62.6 | 4.0 | 7.4 | 7.3 |
| 2-Pentylfuran | 3.5 | 1.5 | 1.5 | 0.9 |
| Benzaldehyde | 12.1 | 2.3 | 2.3 | 2.1 |
| Nonanal | 3.4 | 1.3 | 1.2 | 1.6 |

The isoflavone content of the resin treated suspension over the course of the 135 minutes of operation is summarized below in Table 22.

TABLE 22

| | Content (ppm) | | |
|---|---|---|---|
| Isoflavone | 0 min | 45 min | 135 min |

| | | | |
|---|---|---|---|
| Daidzin | 18.0 | 2.00 | 2.00 |
| 6-OMal-Daidzin | 69.0 | 8.00 | 11.0 |
| 6-OAc-Daidzin | 2.00 | <1.00 | <1.00 |
| Daidzein | 7.00 | 2.00 | 2.00 |
| Total Daidzein Compounds | 96.0 | 12.0 | 15.0 |
| Genistin | 22.0 | 2.00 | 2.00 |
| 6-OMal-Genistin | 81.0 | 10.0 | 13.0 |
| 6-OAc-Genistin | 3.00 | <1.00 | <1.00 |
| Genistein | 7.00 | 2.00 | 3.00 |
| Total Genistein Compounds | 113 | 14.0 | 18.0 |
| Glycitin | 6.00 | 1.00 | 1.00 |
| 6-OMal-Glycitin | 12.0 | 1.00 | 2.00 |
| Glycitein | 1.00 | <1.00 | <1.00 |
| Total Glycitein Compounds | 19.0 | 2.00 | 3.00 |
| Total Isoflavones | 228 | 28.0 | 36.0 |
| Daidzin (aglucone units) | 11.0 | 1.00 | 1.00 |
| 6-OMal-Daidzin (aglucone units) | 35.0 | 4.00 | 6.00 |
| 6-OAc-Daidzin (aglucone units) | 1.00 | <1.00 | <1.00 |
| Daidzein (aglucone units) | 7.00 | 2.00 | 2.00 |
| Total Daidzein (aglucone units) | 54.0 | 7.00 | 9.00 |
| Genistin (aglucone units) | 14.0 | 1.00 | 1.00 |
| 6-OMal-Genistin (aglucone units) | 42.0 | 5.00 | 7.00 |
| 6-OAc-Genistin (aglucone units) | 2.00 | <1.00 | <1.00 |
| Genistein (aglucone units) | 7.00 | 2.00 | 3.00 |
| Total Genistein (aglucone units) | 65.0 | 8.00 | 11.0 |
| Glycitin (aglucone units) | 4.00 | 1.00 | 1.00 |
| 6-OMal-Glycitin (aglucone units) | 6.00 | 1.00 | 1.00 |
| Glycitein (aglucone units) | 1.00 | <1.00 | <1.00 |
| Total Glycitein (aglucone units) | 11.0 | 2.00 | 2.00 |
| Total All Forms (aglucone units) | 130 | 17.0 | 22.0 |

Table 23 shows the mineral content of the control and resin treated samples described above. As shown in Table 23, significant amounts of minerals are not removed by resin treatment. The mineral content of the samples was determined using inductively coupled plasma atomic emission spectroscopy in accordance with Official Methods of Analysis (AOAC) (1995) 16th Ed., Methods, 965.09, Locator #2.6.01; 968.08, Locator #4.8.02; and 984.27, Locator #50.1.05 (Modified).

TABLE 23

| Mineral | Control (ppm) | Resin-treated (ppm) |
|---|---|---|
| Sodium | 8614 | 8187 |
| Potassium | 7115 | 6791 |
| Calcium | 751 | 841 |
| Phosphorus | 8419 | 8733 |
| Magnesium | 433 | 465 |
| Iron | 145 | 161 |
| Manganese | 7.47 | 8.2 |
| Zinc | 30.7 | 32.5 |
| Copper | 14.7 | 16.1 |

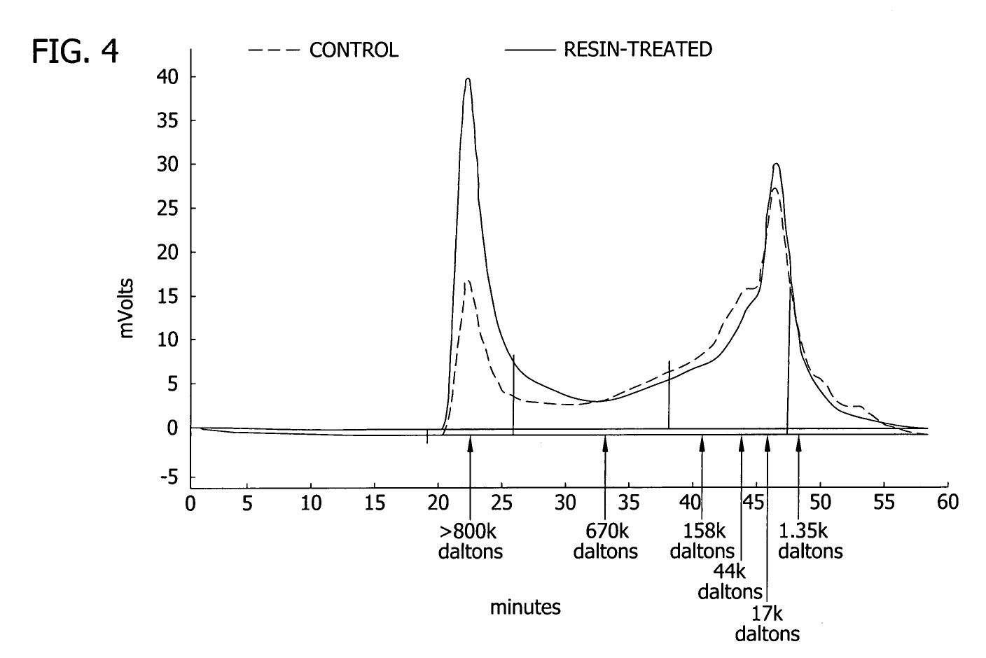

FIG. 4 is an HPLC pattern for a sample resin treated in accordance with the present example. The HPLC pattern is determined as described above in Example 13. As shown in FIG. 4, the resin treated sample exhibits large molecular weight protein aggregation, particularly with respect to proteins having a molecular weight of approximately 800 kilodaltons.

### Example 15

Suspensions of varying viscosities containing soy proteins are prepared and introduced to the resin basket described in Example 1. The resin basket contains between 30 and 35 g of the Amberlite XAD-16HP resin described in Example 1.

A 10% by weight solids aqueous suspension (1 liter) is prepared by adding soy protein concentrate described in Example 12 (100 g) to water (900 g) to produce a suspension having a viscosity of 840 centipoise. The suspension is introduced to the resin basket under the conditions described in Example 1. It is observed that treated suspension does not pass through the resin basket.

An 8% by weight solids aqueous suspension is prepared by adding soy protein concentrate described in Example 12 (80 g) to water (920 g) to produce a suspension having a viscosity of 650 centipoise. The suspension is introduced to the resin basket under the conditions described in Example 1 and treated suspension passes through the resin basket.

A 10% by weight solids aqueous suspension is prepared by adding enzyme-treated soy protein concentrate (the concentrate is treated using a protease enzyme) described in Example 12 (100 g) to water (900 g) to produce an aqueous suspension having a viscosity of 510 centipoise. The suspension is introduced to the resin basket under the conditions described in Example 1 and treated suspension passes through the resin basket.

Aqueous suspensions of varying solids content (5% by weight, 10% by weight, 15% by weight) are prepared by adding soy protein extract described in Example 14 (100 g) to water (900 g) to produce aqueous suspensions having viscosities below 510 centipoise. The suspensions are introduced to the resin basket under the conditions described in Example 1 (e.g., flow rate) and treated suspension passes through the resin basket.

### Example 16

A soy protein extract is prepared by extraction of soy flour at pH 7.0. The soy protein extract in the suspension contains, on a moisture-free basis, approximately 65-67% protein, approximately 8% minerals, approximately 0.6% free fatty acids as determined using the fat ether extraction method, and approximately 25% carbohydrates.

The extract is clarified by centrifugation; a soy protein curd is precipitated from the clarified extract at a pH of approximately 4.5 using hydrochloric acid. The curd is diluted to approximately 5% by weight solids and its pH is adjusted to approximately 7.2. The curd is heat treated at approximately 150° C. (305° F.) and flash cooled to approximately 25° C. (80° F.).

Approximately 90 kg (200 lbs) of the approximately 5% by weight solids heat treated and cooled curd is continuously introduced to a 10 gallon resin basket having a stainless steel sieve having a pore size of from 250 to 300 μm as its bottom wall. The resin basket contains approximately 9 kg (20 lbs) of the moist, adsorbent resin (Sepabeads SP-70), described in Example 2. The pH of the suspension is maintained at 6.8. The 90 kg (200 lbs) of the suspension passes through the resin basket at a flow rate of 1 kg/min (2.3 lbs/min) for 90 minutes.

The resin treated suspension is then heat treated at approximately 150° C. (305° F.), flash cooled to approximately 50° C. (125° F.), and spray dried. Thus, heat treatment and flash cooling are performed twice, on the suspension before resin treatment and on the resin treated suspension.

A control suspension is prepared by preparing a soy protein extract by standard neutral extraction of soy flour. The soy protein extract in the suspension contains, on a moisture-free basis, approximately 65-67% protein, approximately 8% minerals, approximately 0.6% free fatty acids as determined using the fat ether extraction method, and approximately 25% carbohydrates.

The extract is clarified by centrifugation; a soy protein curd is precipitated from the clarified extract at a pH of approximately 4.5 using hydrochloric acid. The curd is diluted to approximately 5% by weight solids and its pH is adjusted to approximately 7.2. The curd is heat treated at approximately 150° C. (305° F.) and flash cooled to approximately 25° C. (80° F.). The control suspension is then heat treated a second time at approximately 150° C. (305° F.), flash cooled a second time to approximately 50° C. (125° F.), and spray dried.

The whiteness index of the control suspension which is heat treated once is 37; the whiteness index of control suspension after heat treatment, flash cooling, and further heat treatment is 48.5; the whiteness index of the resin treated suspension is 50.3.

The amounts of certain volatile components present in the control sample and the resin treated sample (after both heat treatment, flash cooling, and spray drying sequences) are summarized below in Table 24.

TABLE 24

| Volatile Component | Control | Resin Treated |
|---|---|---|
| Pentanal (ppb) | 26.17 | 10.95 |
| Hexanal (ppb) | 83.2 | 45.01 |
| 2-Pentylfuran (ppb) | 2.3 | 1.31 |
| Benzaldehyde (ppb) | 1 | 0.51 |
| Nonanal (ppb) | 0.45 | 0.3 |

The total isoflavone content of the control sample is 1580 ppm; the total isoflavone content of the resin treated sample is 267 ppm. The isoflavone profiles of the control sample and resin treated sample are summarized below in Table 25.

TABLE 25

| Isoflavone profile (ppm) | Control | Resin Treated |
|---|---|---|
| Daidzin | 90.0 | 20.0 |
| 6-OMal-Daidzin | 337 | 38.0 |
| 6-OAc-Daidzin | 33.0 | 3.00 |
| Daidzein | 91.0 | 26.0 |
| Total Daidzein Compounds | 551 | 87.0 |
| Genistin | 158 | 26.0 |
| 6-OMal-Genistin | 580 | 72.0 |
| 6-OAc-Genistin | 68.0 | 10.0 |
| Genistein | 120 | 48.0 |
| Total Genistein Compounds | 926 | 156 |
| Glycitin | 47.0 | 14.0 |
| 6-OMal-Glycitin | 44.0 | 5.00 |
| Glycitein | 14.0 | 5.00 |
| Total Glycitein Compounds | 105 | 24.0 |
| Total Isoflavones | 1580 | 267 |
| Daidzin (aglucone units) | 55.0 | 12.0 |
| 6-OMal-Daidzin (aglucone units) | 171 | 19.0 |
| 6-OAc-Daidzin (aglucone units) | 18.0 | 2.0 |
| Daidzein (aglucone units) | 91.0 | 26.0 |
| Total Daidzein (aglucone units) | 335 | 59.0 |
| Genistin (aglucone units) | 99.0 | 16.0 |
| 6-OMal-Genistin (aglucone units) | 302 | 38.0 |
| 6-OAc-Genistin (aglucone units) | 39.0 | 6.0 |
| Genistein (aglucone units) | 120 | 48.0 |
| Total Genistein (aglucone units) | 560 | 108 |
| Glycitin (aglucone units) | 30.0 | 9.00 |
| 6-OMal-Glycitin (aglucone units) | 23.0 | 3.00 |
| Glycitein (aglucone units) | 14.0 | 5.00 |
| Total Glycitein (aglucone units) | 67.0 | 17.0 |
| Total All Forms (aglucone units) | 962 | 184 |

Other characteristics of the control and resin treated samples are summarized below in Table 26.

TABLE

| | Control | Resin Treated |
|---|---|---|
| Moisture at assay, 133□ C. (%) | 4.10 | 4.03 |
| Protein content (determined by | 89.2 | 89.3 |
| Kjeldahl method) (%) | | |
| Nitrogen Solubility Index (%) | 99.0 | 99.8 |
| Fat, determined by acid | 3.99 | 3.51 |
| hydrolysis (%) | | |
| Ash (%) | 3.26 | 3.43 |

The sensory properties of a control sample, a heat treated control sample, and a heat treated, resin treated sample are evaluated using the procedure and standards described above in Example 13. The results are summarized below in Table 27.

TABLE 27

| | Soy | Bitter- | | |
|---|---|---|---|---|
| Sample | Flavor | ness | Astringency | Comments |
| 5% Slurry of | 2.8 | 3.0 | 3.0 | |
| single heat treated | | | | |
| control sample | | | | |
| 5% Slurry of | 2.4 | 2.8 | 3.2 | Double heat |
| double heat | | | | treated control had |
| treated control | | | | a whiter |
| sample | | | | appearance than |
| | | | | single heat treated |
| | | | | control and |
| | | | | reduced soy flavor |
| | | | | as compared to |
| | | | | single heat treated |
| | | | | control. |
| 5% slurry of | 2.0 | 2.4 | 2.8 | Whiter appearance |
| double heat | | | | than double heat |
| treated, resin | | | | treated control and |
| treated sample | | | | less soy off flavor |
| | | | | as compared to |
| | | | | double heat |
| | | | | treated control. |

### Example 17

A soy protein extract is prepared by standard neutral extraction of soy flour. The soy protein extract in the suspension contains, on a moisture-free basis, approximately 65-67% protein, approximately 8% minerals, approximately 0.6% free fatty acids as determined using the fat ether extraction method, and approximately 25% carbohydrates.

The extract is clarified by centrifugation; a soy protein curd is precipitated from the clarified extract at a pH of approximately 4.5 using hydrochloric acid. The curd is diluted to approximately 12% by weight solids and its pH is adjusted to approximately 7.2. The curd is heat treated at approximately 150° C. (305° F.) and flash cooled to approximately 25° C. (80° F.).

Approximately 75 kg (165 lbs) of the approximately 12% by weight solids heat treated and cooled curd is continuously introduced to a 10 gallon resin basket having a stainless steel sieve having a pore size of from 250 to 300 μm as its bottom wall. The resin basket contains approximately 9 kg (20 lbs) of the moist, adsorbent resin (Sepabeads SP-70), described in Example 2. The pH of the suspension is maintained at 7.2. The 75 kg (165 lbs) of the suspension passes through the resin basket at a flow rate of 1 kg/min (2.2 lbs/min) for 75 minutes.

The resin treated suspension is then heat treated at approximately 150° C. (305° F.), flash cooled to approximately 50° C. (125° F.), and spray dried.

A control suspension is prepared by preparing a soy protein extract by standard neutral extraction of soy flour. The soy protein extract in the suspension contains, on a moisture-free basis, approximately 65-67% protein, approximately 8% minerals, approximately 0.6% free fatty acids as determined using the fat ether extraction method, and approximately 25% carbohydrates.

The extract is clarified by centrifugation; a soy protein curd is precipitated from the clarified extract at a pH of approximately 4.5 using hydrochloric acid. The curd is diluted to approximately 12% by weight solids and its pH is adjusted to approximately 7.2. The curd is heat treated at approximately 150° C. (305° F.) and flash cooled to approximately 25° C. (80° F.). The control suspension is then heat treated once more at approximately 150° C. (305° F.), flash cooled to approximately 50° C. (125° F.), and spray dried.

The whiteness index of the control suspension is 50; the whiteness index of the resin treated suspension is 53.

Viscosities of 10% by weight solids resin treated and control suspensions are determined as described above in Example 13. The viscosity of the control suspension is approximately 59 centipoise while the viscosity of the resin treated suspension is approximately 45 centipoise.

The total isoflavone content of the control sample is 2014 ppm; the total isoflavone content of the resin treated sample is 320 ppm. The isoflavone profiles of the control sample and resin treated sample are summarized below in Table 28.

TABLE 28

| Isoflavone profile (ppm) | Control | Resin Treated |
|---|---|---|
| Daidzin | 40.0 | 4.0 |
| 6-OMal-Daidzin | 442.0 | 62.0 |
| 6-OAc-Daidzin | 40.0 | 4.0 |
| Daidzein | 58.0 | 13.0 |
| Total Daidzein Compounds | 638.0 | 88.0 |
| Genistin | 226.0 | 36.0 |
| 6-OMal-Genistin | 859.0 | 139.0 |
| 6-OAc-Genistin | 90.0 | 15.0 |
| Genistein | 62.0 | 21.0 |
| Total Genistein Compounds | 1237.0 | 211.0 |
| Glycitin | 37.0 | 6.0 |
| 6-OMal-Glycitin | 87.0 | 12.0 |
| Glycitein | 15.0 | 3.0 |
| Total Glycitein Compounds | 139.0 | 21.0 |
| Total Isoflavones | 2014.0 | 320.0 |
| Daidzin (aglucone units) | 60.0 | 5.0 |
| 6-OMal-Daidzin (aglucone units) | 224.0 | 31.0 |
| 6-OAc-Daidzin (aglucone units) | 22.0 | 2.0 |
| Daidzein (aglucone units) | 58.0 | 13.0 |
| Total Daidzein (aglucone units) | 364.0 | 51.0 |
| Genistin (aglucone units) | 141.0 | 23.0 |
| 6-OMal-Genistin (aglucone units) | 448.0 | 72.0 |
| 6-OAc-Genistin (aglucone units) | 51.0 | 9.0 |
| Genistein (aglucone units) | 62.0 | 21.0 |
| Total Genistein (aglucone units) | 702.0 | 125.0 |
| Glycitin (aglucone units) | 24.0 | 4.0 |
| 6-OMal-Glycitin (aglucone units) | 46.0 | 6.0 |
| Glycitein (aglucone units) | 15.0 | 3.0 |
| Total Glycitein (aglucone units) | 85.0 | 13.0 |
| Total All Forms (aglucone units) | 1151 | 189 |

Other characteristics of the control and resin treated samples are summarized below in Table 29.

TABLE

| | Control | Resin Treated |
|---|---|---|
| Moisture at assay, 133° C. (%) | 4.16 | 4.16 |
| Protein content (determined by | 89.6 | 89.1 |
| Kjeldahl method) (%) | | |
| Nitrogen Solubility Index (%) | 92.9 | 96.5 |
| Fat, determined by acid | | |
| hydrolysis (%) | | |
| Ash (%) | 4.49 | 4.56 |

Resin treated samples are tested for flavor by a trained panel of testers. Twelve trained descriptive panelists evaluate 5 wt. % slurries of the resin treated samples and control samples in triplicate. The samples are evaluated for twenty-seven flavor and eight texture attributes.

The slurries to be analyzed are prepared by adding a sample (50 g) to water (950 ml) and blending the mixture. The slurry is transferred to a sterile Nalgene® flask and refrigerated at 4° C. for at least 12 hours. After refrigeration, samples of the slurry are poured into 105 ml (3.5 oz.) opaque Solo® cups for testing. The flasks are shaken before the samples are introduced into the cups to re-suspend any precipitated solids.

Each panelist independently rated the intensity of each sample's flavor attributes on a 15-point intensity scale, with 0=none and 15=very strong. Samples were randomized and presented monadically in duplicate.

Analysis of Variance (ANOVA) was performed to test product and replication effects. When the ANOVA result was significant, multiple comparisons of means were performed using the Turkey's t-test. All differences were significant at an<0.05 level unless otherwise noted.

The results for flavor profiling are described in Table 30. For flavor attributes, mean values<1.0 indicate that not all panelists perceived the attribute in the sample. Means in the same row followed by the same letter are not significantly different at an=0.05 level.

TABLE 30

| AROMATICS | Control | Resin Treated |
|---|---|---|
| Overall Flavor Impact | 5.9a | 5.8b |
| Green Complex | 2.4a | 2.4a |
| Viney | 0.0a | 0.0a |
| Grassy | 2.3a | 2.3a |
| Beany | 0.0a | 0.0a |
| GRAIN | 0.5a | 0.1b |
| Soy/Legume | 3.0a | 3.1a |
| Sweet Aromatics | 0.0a | 0.0a |
| Woody | 0.0a | 0.0a |
| Nutty | 0.0a | 0.0a |
| Dairy | 0.0a | 0.0a |
| Cardboard | 2.4a | 2.1b |
| Painty | 0.0a | 0.0a |
| Degraded Protein | 0.5a | 0.0b |

The resin treated samples were observed to have significantly improved flavor and reduced grain and degraded protein aromatics as compared to a control sample.

Table 31 shows the mineral content of the control and resin treated samples described above. As shown in Table 31, significant amounts of minerals are not removed by resin treatment. The mineral content of the samples was determined using inductively coupled plasma atomic emission spectroscopy in accordance with Official Methods of Analysis (AOAC) (1995) 16th Ed., Methods, 965.09, Locator #2.6.01; 968.08, Locator #4.8.02; and 984.27, Locator #50.1.05 (Modified).

TABLE 31

| | Control (ppm) | Resin-treated (ppm) |
|---|---|---|
| | (double | (double heat-treated, |
| Mineral | heat-treated) | resin treated) |
| Sodium | 7892 | 7983 |
| Potassium | 8142 | 8019 |
| Calcium | 685 | 694 |
| Phosphorus | 9951 | 9648 |
| Magnesium | 544 | 525 |
| Iron | 98.4 | 101 |
| Manganese | 11.1 | 10.7 |
| Zinc | 34.4 | 35 |
| Copper | 15.6 | 15.2 |

### Example 18

An aqueous suspension is prepared by adding Promine DS soy protein concentrate (50 g) produced by the Solae Company (St. Louis, Mo.) to deionized water (500 ml); the aqueous suspension contains approximately 10% by weight solids. The pH of the suspension is adjusted to 9.5 by adding 1N sodium hydroxide.

The suspension is agitated for 1 hour using a Ceramag Midi stir plate manufactured by IKA Works, Inc. (Wilmington, Del.). The suspension is then transferred to 250 ml centrifuge tubes and the samples are centrifuged at approximately 3600 revolutions per minute (rpm) for approximately 20 minutes in an Avanti J-25 centrifuge manufactured by Beckman Instruments (Schaumburg, Ill.). Overflow of suspension from the centrifuge tubes is filtered by vacuum filtration using a Model No. 4 filter manufactured by Whatman Instruments, Ltd. (Maidstone, England) to remove solids that could foul the column.

The size exclusion column is prepared by adding 1000 m³ of a Toyopearl HW-55F size exclusion resin manufactured by Tosoh Biosciences (Montgomeryville, Pa.) to a glass column having a diameter of 1.5 cm and a height of 67 cm. The resin bed height is approximately 53 cm. The size exclusion resin has a fractionation range of from 1000 to 700,000 daltons and a particle size of from 30 to 60 □m. The column is packed by allowing five column volumes of eluant to flow through the resin bed.

The suspension is introduced to the column and purified protein fraction begins eluting at 735 minutes and ends at 1155 minutes. Fractions eluting from 0-735 minutes were clear to colorless; fractions eluting from 735-1155 minutes were milky white; fractions eluting after 1155 minutes blend from opaque tan changing to clear yellow/orange, back to clear colorless. It is currently believed that the color components removed reside in the fractions eluted after 1155 minutes.

The moisture content, protein content, carbohydrate content, whiteness index, and isoflavone profile of the suspension, before and after treatment using the size exclusion resin, are described below in Table 32.

The moisture contents of the suspension before and after treatment are determined by Official Methods of Analysis of the AOAC, 16th Edition, (1995); Method 934.06, Locator # 37.1.10; 925.45, and 925.45A, Locator # 44.1.03.

The protein contents of the suspension before and after treatment are determined by the Nitrogen-Ammonia-Protein Modified Kjeldahl method described, for example, in A.O.C.S. (American Oil Chemists Society) Official Methods Bc 4-91(1997), Aa 5-91(1997), or Ba 4d-90(1997).

The carbohydrate content of various sugars in the suspension before and after treatment is determined by High Performance Liquid Chromotagraphy (HPLC) using a Beckman Instruments Chromatograph equipped with a UV detector and a Hypersil column having a 2.1 mm diameter and 200 mm height manufactured by Hewlett-Packard (Palo Alto, Calif.). The stachyose and raffinose contents are also determined by HPLC in this manner.

Whiteness index measurements of a 5% by weight solids sample of the suspension before and after treatment are determined using a HunterLab DP-9000 colorimeter including an optical sensor D-25, both manufactured by Hunter Associates Laboratory (HunterLab) (Reston, Va.). For the whiteness index measurement before treatment, Promine DS soy protein concentrate (5.25 g) is added to deionized water (100 ml) and the pH of the sample is adjusted to 7 using 1N sodium hydroxide. For the whiteness index measurements of the suspension after treatment, a soy protein curd is precipitated from the treated suspension by adjusting the pH of the treated suspension to pH 4.5 by addition of 1N hydrochloric acid and centrifuging at 3600 rpm for 20 minutes using the centrifuge described above. The pH of a 5% by weight solids sample of the soy protein curd is adjusted to 7 using 1N sodium hydroxide and its whiteness index is measured.

The isoflavone profile of the suspension before and after treatment is determined by HPLC using the Beckman Instruments chromatograph described above.

TABLE 32

| | Before Treatment | After Treatment |
|---|---|---|
| Moisture Content | 4.84 | 82.6 |
| Total Protein | 65.4 | 17.8 |
| Protein (dry basis) | 68.72 | 98.86 |
| Sugar Profile (% by weight) | | |
| Fructose | <0.2 | <0.2 |
| Glucose | <0.2 | <0.2 |
| Sucrose | 0.32 | <0.2 |
| Maltose | <0.2 | <0.2 |
| Lactose | <0.2 | <0.2 |
| Additional Carbohydrates | | |
| (% by weight) | | |
| Stachyose | 1.96 | <0.2 |
| Raffinose | <0.2 | <0.2 |
| Color (5% solids, pH 7.0) | | |
| L | 69.32 | 60.24 |
| a | −2.01 | −2.65 |
| b | 10.98 | −7.25 |
| WI | 36.39 | 81.99 |
| Isoflavone Profile (ppm) | | |
| Daidzin | 16.0 | <1 |
| 6-OMal-Daidzin | 16.0 | <1 |
| 6-OAc-Daidzin | 4.0 | <1 |
| Daidzein | <1 | <1 |
| Moisture Content | 4.84 | 82.6 |
| Total Daidzein Compounds | 36.0 | <1 |
| Genistin | 26.0 | <1 |
| 6-OMal-Genistin | 18.0 | <1 |
| 6-OAc-Genistin | 5.0 | <1 |
| Genistein | <1 | <1 |
| Total Genistein Compounds | 49.0 | <1 |
| Glycitin | 6.0 | <1 |
| 6-OMal-Glycitin | 4.0 | <1 |
| Glycitein | <1 | <1 |
| Total Glycitein Compounds | 10.0 | <1 |
| Total Isoflavones | 95.0 | <1 |
| Daidzin (aglucone units) | 10.0 | <1 |
| 6-OMal-Daidzin (aglucone units) | 8.0 | <1 |
| 6-OAc-Daidzin (aglucone units) | 2.0 | <1 |
| Daidzein (aglucone units) | <1 | <1 |
| Total Daidzein (aglucone units) | 20.0 | <1 |
| Genistin (aglucone units) | 16.0 | <1 |
| 6-OMal-Genistin (agluconeunits) | 9.0 | <1 |
| 6-OAc-Genistin (aglucone units) | 3.0 | <1 |
| Genistein (aglucone units) | <1 | <1 |
| Total Genistein (aglucone units) | 28.0 | <1 |
| Glycitin (aglucone units) | 4.0 | <1 |
| 6-OMal-Glycitin (aglucone units) | 2.0 | <1 |
| Glycitein (aglucone units) | <1 | <1 |
| Moisture Content | 4.84 | 82.6 |
| Total Glycitein (aglucone units) | 6.0 | <1 |
| Total All Forms (aglucone units) | 54.0 | <1 |

As shown in Table 32, treating the dispersion prepared as described above using the size exclusion resin increases its protein content, reduces the sucrose and stachyose content, increases its whiteness index, and provides a treated composition having a reduced isoflavone content.

### Example 19

An aqueous suspension is prepared by adding commodity white soy protein flakes (50.0 g) produced by Cargill, Inc. (Minneapolis, Minn.) to deionized water (500 ml); the aqueous suspension contains approximately 10% by weight solids. The pH of the suspension is adjusted to 9.5 by adding 1N sodium hydroxide. The suspension is agitated, centrifuged, and filtered as described above in Example 18.

The suspension is treated using the column and size exclusion resin described above in Example 18. The moisture content, protein content, whiteness index, and isoflavone profile of the suspension before and after treatment using the size exclusion resin, are determined as described above in Example 18. For the whiteness index measurement before treatment, commodity white soy protein flakes described above in the present example (5.29 g) are added to deionized water (100 ml) and the pH of the sample is adjusted to 7 using 1N sodium hydroxide. For the whiteness index measurements of the suspension after treatment, a soy protein curd is precipitated from the treated suspension as described above in Example 18. The pH of a 5% by weight solids sample of the soy protein curd is adjusted to 7 using 1N sodium hydroxide and its whiteness index is measured. The results are shown below in Table 33.

TABLE 33

| | Before Treatment | After Treatment |
|---|---|---|
| Moisture Content | 5.62 | 78.2 |
| Total Protein | 50 | 21.5 |
| Protein (dry basis) | 52.98 | 98.62 |
| Sugar Profile (% by weight) | | |
| Fructose | <0.2 | <0.2 |
| Glucose | <0.2 | <0.2 |
| Sucrose | 8.23 | <0.2 |
| Maltose | <0.2 | <0.2 |
| Lactose | <0.2 | <0.2 |
| Additional Carbohydrates | | |
| (% by weight) | | |
| Stachyose | 4.59 | <0.2 |
| Raffinose | 0.65 | <0.2 |
| Color (5% solids, pH 7.0) | | |
| L | 60.3 | 46.54 |
| a | −2.87 | −2.49 |
| b | 14.45 | −7.12 |
| WI | 16.94 | 67.9 |
| Isoflavone Profile (ppm) | | |
| Daidzin | 598.0 | <1 |
| 6-OMal-Daidzin | 1900.0 | <1 |
| 6-OAc-Daidzin | 55.0 | <1 |
| Daidzein | 22.0 | <1 |
| Total Daidzein Compounds | 2580.0 | <1 |
| Genistin | 772.0 | <1 |
| 6-OMal-Genistin | 2220.0 | <1 |
| 6-OAc-Genistin | 65.0 | <1 |
| Genistein | 18.0 | <1 |
| Total Genistein Compounds | 3070.0 | <1 |
| Glycitin | 111.0 | <1 |
| 6-OMal-Glycitin | 227.0 | <1 |
| Glycitein | 1.0 | <1 |
| Total Glycitein Compounds | 339.0 | <1 |
| Total Isoflavones | 5990.0 | <1 |
| Daidzin (aglucone units) | 365.0 | <1 |
| 6-OMal-Daidzin (aglucone units) | 963.0 | <1 |
| 6-OAc-Daidzin (aglucone units) | 31.0 | <1 |
| Daidzein (aglucone units) | 22.0 | <1 |
| Total Daidzein (aglucone units) | 1380.0 | <1 |
| Genistin (aglucone units) | 483.0 | <1 |
| 6-OMal-Genistin (aglucone units) | 1150.0 | <1 |
| 6-OAc-Genistin (aglucone units) | 37.0 | <1 |
| Genistein (aglucone units) | 18.0 | <1 |
| Total Genistein (aglucone units) | 1690.0 | <1 |
| Glycitin (aglucone units) | 71.0 | <1 |
| 6-OMal-Glycitin (aglucone units) | 121.0 | <1 |
| Glycitein (aglucone units) | 1.0 | <1 |
| Total Glycitein (aglucone units) | 193.0 | <1 |
| Total All Forms (aglucone units) | 3270.0 | <1 |

As shown in Table 33, treating the dispersion prepared as described above using the size exclusion resin increases its protein content, reduces the sucrose, stachyose, and raffinose content; increases its whiteness index; and provides a treated composition having a reduced isoflavone content.

### Example 20

An aqueous suspension is prepared by adding soybeans from seeds obtained from Stine Seed Co. (Adel, Iowa), Variety 806301-03, Lot No. FCISOE 203) ground using a 1 mm screen to produce a fine powder (50.0 g) to deionized water (500 ml); the aqueous suspension contains approximately 10% by weight solids. The pH of the suspension is adjusted to 9.5 by adding 1N sodium hydroxide. The suspension is agitated, centrifuged, and filtered as described above in Example 18.

The suspension is treated using the column and size exclusion resin described above in Example 18. The moisture content, protein content, whiteness index, and isoflavone profile of the suspension, before and after treatment using the size exclusion resin, are determined as described above in Example 18. For the whiteness index measurement before treatment, powder prepared as described above in the present example (5.35 g) is added to deionized water (100 ml) and the pH of the sample is adjusted to 7 using 1N sodium hydroxide. For the whiteness index measurements of the suspension after treatment, a soy protein curd is precipitated from the treated suspension as described above in Example 18. The pH of a 5% by weight solids sample of the soy protein curd is adjusted to 7 using 1N sodium hydroxide and its whiteness index is measured. The results are shown below in Table 34.

TABLE 34

| | Before Treatment | After Treatment |
|---|---|---|
| Moisture Content | 6.58 | 77.1 |
| Total Protein | 36.8 | 22.2 |
| Protein (dry basis) | 39.39 | 96.94 |
| Sugar Profile (% by weight) | | |
| Fructose | <0.2 | <0.2 |
| Glucose | <0.2 | <0.2 |
| Sucrose | 5.75 | <0.2 |
| Maltose | <0.2 | <0.2 |
| Lactose | <0.2 | <0.2 |
| Additional Carbohydrates | | |
| (% by weight) | | |
| Stachyose | 3.4 | <0.2 |
| Raffinose | 0.75 | <0.2 |
| Color (5% solids, pH 7.0) | | |
| L | 75.7 | 74.06 |
| a | −1.97 | −3.18 |
| b | 19.65 | 4.24 |
| WI | 16.74 | 61.33 |
| Isoflavone Profile (ppm) | | |
| Daidzin | 408.0 | <1 |
| 6-OMal-Daidzin | 972.0 | <1 |
| 6-OAc-Daidzin | 14.0 | <1 |
| Daidzein | 10.0 | <1 |
| Total Daidzein Compounds | 1400.0 | <1 |
| Genistin | 669.0 | <1 |
| 6-OMal-Genistin | 1520.0 | <1 |
| 6-OAc-Genistin | 21.0 | <1 |
| Genistein | 12.0 | <1 |
| Total Genistein Compounds | 2220.0 | <1 |
| Glycitin | 77.0 | <1 |
| 6-OMal-Glycitin | 138.0 | <1 |
| Glycitein | <1 | <1 |
| Total Glycitein Compounds | 215.0 | <1 |
| Total Isoflavones | 3840.0 | <1 |
| Daidzin (aglucone units) | 249.0 | <1 |
| 6-OMal-Daidzin (aglucone units) | 492.0 | <1 |
| 6-OAc-Daidzin (aglucone units) | 8.0 | <1 |
| Daidzein (aglucone units) | 10.0 | <1 |
| Total Daidzein (aglucone units) | 759.0 | <1 |
| Genistin (aglucone units) | 418.0 | <1 |
| 6-OMal-Genistin (aglucone units) | 790.0 | <1 |
| 6-OAc-Genistin (aglucone units) | 12.0 | <1 |
| Genistein (aglucone units) | 12.0 | <1 |
| Total Genistein (aglucone units) | 1230.0 | <1 |
| Glycitin (aglucone units) | 49.0 | <1 |
| 6-OMal-Glycitin (aglucone units) | 74.0 | <1 |
| Glycitein (aglucone units) | <1 | <1 |
| Total Glycitein (aglucone units) | 123.0 | <1 |
| Total All Forms (aglucone units) | 2110.0 | <1 |

As shown in Table 34, treating the dispersion prepared as described above using the size exclusion resin increases its protein content, reduces the sucrose, stachyose, and raffinose content; increases its whiteness index; and provides a treated composition having a reduced isoflavone content.

### Example 21

An aqueous suspension is prepared by adding Supro 670 soy protein isolate (50.0 g) produced by the Solae Company (St. Louis, Mo.) to deionized water (500 ml); the aqueous suspension contains approximately 10% by weight solids. The pH of the suspension is adjusted to 9.5 by adding 1N sodium hydroxide. The suspension is agitated, centrifuged, and filtered as described above in Example 18.

The suspension is treated using the column and size exclusion resin described above in Example 18. The moisture content, protein content, whiteness index, and isoflavone profile of the suspension, before and after treatment using the size exclusion resin, are determined as described above in Example 18. For the whiteness index measurement before treatment, soy protein isolate described above in the present example (5.21 g) is added to deionized water (100 ml) and the pH of the sample is adjusted to 7 using 1N sodium hydroxide. For the whiteness index measurements of the suspension after treatment, a soy protein curd is precipitated from the treated suspension as described above in Example 18. The pH of a 5% by weight solids sample of the soy protein curd is adjusted to 7 using 1N sodium hydroxide and its whiteness index is measured. The results are shown below in Table 35.

TABLE 35

| | Before Treatment | After Treatment |
|---|---|---|
| Moisture Content | 4.06 | 84.9 |
| Total Protein | 86.7 | 13.2 |
| Protein (dry basis) | 90.36 | 87.42 |
| Sugar Profile (% by weight) | | |
| Fructose | <0.2 | <0.2 |
| Glucose | <0.2 | <0.2 |
| Sucrose | <0.2 | <0.2 |
| Maltose | <0.2 | <0.2 |
| Lactose | <0.2 | <0.2 |
| Additional Carbohydrates | | |
| (% by weight) | | |
| Stachyose | <0.2 | <0.2 |
| Raffinose | <0.2 | <0.2 |
| Color (5% solids, pH 7.0) | | |
| L | 79.09 | 68.1 |
| a | −0.93 | −3.11 |
| b | 12.53 | 1.85 |
| WI | 41.49 | 62.55 |
| Isoflavone Profile (ppm) | | |
| Daidzin | 144.0 | <1 |
| 6-OMal-Daidzin | 334.0 | <1 |
| 6-OAc-Daidzin | 36.0 | <1 |
| Daidzein | 23.0 | 1.0 |
| Total Daidzein Compounds | 537.0 | 1.0 |
| Genistin | 347.0 | 1.0 |
| 6-OMal-Genistin | 611.0 | <1 |
| 6-OAc-Genistin | 84.0 | <1 |
| Genistein | 34.0 | 2.0 |
| Total Genistein Compounds | 1080.0 | 3.0 |
| Glycitin | 25.0 | <1 |
| 6-OMal-Glycitin | 31.0 | <1 |
| Glycitein | 3.0 | 2.0 |
| Total Glycitein Compounds | 59.0 | 2.0 |
| Total Isoflavones | 1670.0 | 5.0 |
| Daidzin (aglucone units) | 88.0 | <1 |
| 6-OMal-Daidzin (aglucone units) | 169.0 | <1 |
| 6-OAc-Daidzin (aglucone units) | 20.0 | <1 |
| Daidzein (aglucone units) | 23.0 | 1.0 |
| Total Daidzein (aglucone units) | 300.0 | 1.0 |
| Genistin (aglucone units) | 217.0 | 1.0 |
| 6-OMal-Genistin (aglucone units) | 318.0 | <1 |
| 6-OAc-Genistin (aglucone units) | 48.0 | <1 |
| Genistein (aglucone units) | 34.0 | <1 |
| Total Genistein (aglucone units) | 617.0 | 3.0 |
| Glycitin (aglucone units) | 16.0 | <1 |
| 6-OMal-Glycitin (aglucone units) | 17.0 | <1 |
| Glycitein (aglucone units) | 3.0 | 1.0 |
| Total Glycitein (aglucone units) | 36.0 | 1.0 |
| Total All Forms (aglucone units) | 953.0 | 5.0 |

As shown in Table 35, treating the dispersion prepared as described above using the size exclusion resin increases its whiteness index and provides a treated composition having a reduced isoflavone content.

1. A composition comprising a soy protein material, the composition being in solid or liquid form, the composition being characterized in that an aqueous mixture of the composition has a whiteness index of at least 50 and an L value of less than 78 when the aqueous mixture has a soy protein content of 2 to 3% by weight and a pH of 6.8 to 7.2, wherein the whiteness index (WI) is determined using the equation WI=L−3b and L and b are determined using a colorimeter, L being a measure of the whiteness of the composition with the value of L ranging from 0 to 100 with increasing whiteness and b being a measure of the presence of yellow or blue colors in the composition, with positive b values indicating the presence of yellow colors and negative b values indicating the presence of blue colors.

2. The composition of claim 1 wherein the composition is in the form of a solid, the composition being characterized in that an aqueous mixture is prepared by combining the solid with deionized water and acid or base, as necessary, to form the aqueous mixture.

3. The composition of claim 1 wherein the composition is in a liquid form, the composition being characterized in that an aqueous mixture of the liquid form is prepared by adjusting the water content of the aqueous mixture, as necessary, and adjusting the pH of the aqueous mixture, as necessary.

4. The composition of claim 3 wherein the liquid form contains more than 3% by weight soy protein and the aqueous mixture is prepared from the liquid form by adding deionized water to the liquid to decrease the soy protein content to a value of 2 to 3% by weight.

5. The composition of claim 3 wherein the liquid form contains less than 2% by weight soy protein and the aqueous mixture is prepared by reducing the water content of the liquid form to increase the soy protein content to a value of 2 to 3% by weight.

6. The composition of claim 1 wherein the composition is in the form of an aqueous mixture having a soy protein content of 2 to 3% by weight, a pH of 6.8 to 7.2, a whiteness index of at least 50 and an L value of less than 78, as determined using a calorimeter.

7. The composition of claim 1 wherein the L value is less than 70.

8. The composition of claim 1 wherein the whiteness index is greater than 60.

9. The composition of claim 1 wherein the whiteness index is less than 85.

10. The composition of claim 1 wherein the b value for an aqueous mixture of the composition is less than 9 when the aqueous mixture has a soy protein content of 2 to 3% by weight and a pH of 6.8 to 7.2.

11. The composition of claim 1 wherein the soy protein material is selected from the group consisting of soy flakes, soy grits, soy meal, soy flour, soy protein concentrates, soy protein isolates, and combinations thereof.

12. The composition of claim 11 wherein the composition is in the form of a free-flowing solid.

13. The composition of claim 11 wherein the composition is in the form of an aqueous mixture.

14. The composition of claim 1 wherein the composition contains no more than 500 ppm of low molecular weight components (i) having a molecular weight of from 80 to 17,000 daltons and (ii) which absorb ultraviolet radiation having a wavelength of from 200 to 400 nm.

15. The composition of claim 14 wherein the composition contains no more than 350 ppm of said low molecular weight components.

16. The composition of claim 1 wherein the composition contains no more than 150 ppb of volatile components selected from aldehydes containing less than 10 carbon atoms, ketones containing less than 10 carbon atoms, and combinations thereof.

17. The composition of claim 16 wherein the composition contains no more than 50 ppb of said volatile components.

18. The composition of claim 1 wherein the composition contains, in combination, no more than 500 ppm of isoflavones selected from the group consisting of (i) aglucone and non aglucone type daidzin, daidzein, genistin, genistein, glycitin, and glycitein isoflavones, and (ii) the malonyl and acetyl esters of aglucone and non aglucone type daidzin, daidzein, genistin, genistein, glycitin, and glycitein isoflavones.

19. The composition of claim 18 wherein the composition contains, in combination, no more than 50 ppm of said isoflavones.

20. The composition of claim 1 wherein the soy protein material is produced by a process comprising:
introducing a feed soy protein-containing material into a contact vessel containing a mass of an adsorbent resin to form a mixture within an adsorption zone of the contact vessel to treat the soy protein-containing material, the resin being selective for adsorption of one or more components of the feed soy protein-containing material,
agitating the mixture to form a dispersion of the resin in the composition, the resin being free to move throughout the dispersion in the adsorption zone to form a treated soy protein-containing material, and
removing the treated soy protein-containing material from the contact vessel as the feed is introduced into the contact vessel.

21. The composition of claim 1 wherein the soy protein material is produced by a process comprising:
feeding a food-grade, soy protein-containing material to a chromatographic separation zone, the chromatographic separation zone comprising a bed of size exclusion resin, the resin having a size exclusion limit,
passing the food-grade soy protein-containing material through the bed of size exclusion resin to reduce the concentration of components having a molecular weight less than the size exclusion limit of the resin in the food-grade material to form a reduced component concentration soy protein-containing material, and
eluting the reduced component concentration soy protein-containing material from the chromatographic separation zone after it has passed through the bed of size exclusion resin.

22. The composition of claim 1 wherein the soy protein material is produced by a process comprising:
feeding a soy protein-containing material to a chromatographic separation zone, the soy protein-containing material comprising at least two soy proteins having a molecular weight of at least 50,000 daltons, the chromatographic separation zone comprising a bed of size exclusion resin having a size exclusion limit of S, wherein S is no more than 50,000 daltons, whereby components of the soy protein material having a molecular weight less than S are retained by the resin and components having a molecular weight greater than S are not retained by the resin,
passing the soy protein-containing material through the bed of size exclusion resin to reduce the concentration of components having a molecular weight less than the size exclusion limit of the resin in the soy protein-containing material to form a reduced component concentration soy protein material, and
eluting the reduced component concentration soy protein material from the chromatographic separation zone after it has passed through the bed of size exclusion resin wherein the weight ratio of any two soy proteins having a molecular weight of at least 50,000 daltons in the eluted composition is within 20% of the weight ratio of the same two soy proteins in the feed soy protein-containing material.

23. A composition comprising a soy protein material and one or more isoflavones selected from: (i) aglucone and non aglucone type daidzin, daidzein, genistin, genistein, glycitin, and glycitein isoflavones and (ii) the malonyl and acetyl esters of aglucone and non aglucone type daidzin, daidzein, genistin, genistein, glycitin, and glycitein isoflavones, wherein the weight ratio of soy protein to the combined weight of all such isoflavones is at least 3,000:1, respectively.

24. The composition of claim 23 wherein the weight ratio of soy protein to the combined weight of all such isoflavones is at least 5,000:1, respectively.

25. The composition of claim 23 wherein the weight ratio of soy protein to the combined weight of all such isoflavones is at least 10,000:1, respectively.
